(19) United States
(12) Patent Application Publication
(10) Pub. No.: US 2024/0059831 A1
(43) Pub. Date: Feb. 22, 2024

(54) CURABLE COMPOSITION AND CURED PRODUCT OF THE SAME, AND WAFER-LEVEL LENS

(71) Applicant: DAICEL CORPORATION, Osaka (JP)

(72) Inventor: Hiroki TAKENAKA, Tokyo (JP)

(73) Assignee: DAICEL CORPORATION, Osaka (JP)

(21) Appl. No.: 18/231,347

(22) Filed: Aug. 8, 2023

(30) Foreign Application Priority Data
Aug. 10, 2022 (JP) 2022-128368

(51) Int. Cl. C08G 59/68; C09D 163/00

(52) U.S. Cl. CPC C08G 59/68; C09D 163/00

(57) ABSTRACT

An object of the present disclosure is to provide a curable composition excellent in curability (especially high-speed curability) and capable of forming a cured product excellent in heat resistance (especially reflow heat resistance), and to provide a wafer-level lens formed by using the curable composition and a method for producing the wafer-level lens.

A curable composition of the present disclosure includes the following components (A) and (B).
component (A): a compound including an alicyclic epoxy group and including no ester bond, and
component (B): a cationic polymerization initiator including a cation moiety and an anion moiety containing a gallium atom.

### TECHNICAL FIELD

The present disclosure relates to a curable composition, a cured product of the curable composition, and a wafer-level lens obtained using the curable composition.

### BACKGROUND ART

In recent years, optical devices, such as mobile cameras mounted on mobile products, typical examples of which include cellular phones, smartphones, tablet terminals and mobile computers, vehicle-mounted cameras, and optical communication lenses, have significantly been reduced in size and weight, and have achieved significantly enhanced performance. Along with such a technical trend, there is an increasing demand for reduction in size, weight, and thickness of a lens used in a camera or the like that is mounted on such optical devices, and a wafer-level lens has come to be used as a lens that satisfies such demand.

With an increase in the number of pixels of an imaging element of a camera and the like, a lens having resolution capable of supporting the increased number of pixels is required, and for example, a cemented lens in which two or more lenses are laminated is used. A wafer-level lens is suitable for use in such application. In general, since a refractive index of a lens varies depending on the wavelength of light, a phenomenon (chromatic aberration) occurs in which a shift (bleeding, blurring, or the like) occurs in an image. To reduce the influence of the chromatic aberration, a typical a structure in which a lens having a high Abbe number and a lens having a low Abbe number are used in combination to correct the chromatic aberration. Glass of lenses used in cameras is generally called flint glass when the Abbe number is 50 or less, and crown glass when the Abbe number is 50 or more.

As a material used for the wafer-level lens discussed above, a curable resin material has attracted attention. To efficiently produce a high-quality wafer-level lens, there is a demand for a curable resin material capable of forming a cured product that is excellent in curability (particularly, high-speed curability where heating for about two to three minutes can cure the material rapidly), heat resistance (particularly, heat resistance where the material is resistant to discoloration even when subjected to heat treatment in a reflow process), moldability (for example, a low shrinkage rate or a low linear expansion coefficient), and the like.

For example, when curability is low, a long time is required for the molding process, thereby lowering the productivity. A camera module including a wafer-level lens typically undergoes a reflow process in which an electrode is bonded to a wiring substrate by soldering. In recent years, lead-free solder having a high melting point has been used as the solder as a bonding material, and heat treatment in the reflow process employs a higher temperature (for example, a peak temperature of 240 to 260° C.). Under such circumstances, in a camera module of related art, there is such a problem that coloring such as yellowing occurs in a wafer-level lens due to heat treatment in the reflow process, resulting in a low transparency. Accordingly, a wafer-level lens used in an optical product is required to have excellent heat resistance, in particular, heat resistance that prevents discoloration from occurring even when the lens is subjected to heat treatment in the reflow process (hereinafter, may be referred to as “reflow heat resistance”).

Furthermore, when a curable resin material whose resultant cured product has a high shrinkage rate and a high linear expansion coefficient is used, the accuracy of the lens shape is poor, and the quality and productivity of the wafer-level lens are adversely affected.

It is known that a thermoplastic resin such as a cycloolefin polymer or polycarbonate is used as a resin material for a lens (for example, refer to Patent Document 1). However, since the thermoplastic resin is inferior in heat resistance, it cannot be used in a mounting process at a high temperature such as reflow, in an application requiring heat resistance in a usage environment at a high temperature, and the like.

As a method for solving the issue of heat resistance, a method of using an epoxy compound with a structure including an isocyanuric ring as a main skeleton may be cited (for example, refer to Patent Document 2). However, since an epoxy resin composition containing an isocyanuric ring is inferior in curability, it is difficult to use the epoxy resin composition as a material for a wafer-level lens that is required to be rapidly cured by heating for about two to three minutes. Moreover, the cured product obtained is likely to undergo yellowing when exposed to a high temperature environment for a long period of time, and it is difficult to maintain transparency.

In an epoxy resin composition having both high curability and excellent transparency, an antimony-based acid generator is used in many cases (for example, refer to Patent Documents 3 and 4). However, since antimony compounds are specified in the Joint Industry Guide (JIG) as substances subject to control with a threshold level of 1000 ppm, the use of a non-antimony-based acid generator is essential, but the non-antimony-based acid generator is poor in curability and heat resistance, thereby causing yellowing or the like.

As an acid generator excellent in transparency and heat resistance, a phosphorus-based acid generator containing phosphorus hexafluoride or the like as an anion component is used (for example, refer to Patent Document 5), but there is a problem of poor curability. As a non-antimony-based acid generator having high curability, a special phosphorus-based or borate-based acid generator may be cited, but there is such a problem that yellowing is likely to occur or the like.

### CITATION LIST

### Patent Document

Patent Document 1: JP 9-263627 A
Patent Document 2: JP 2000-344867 A
Patent Document 3: JP 2008-274262 A
Patent Document 4: JP 2009-132834 A
Patent Document 5: JP 2009-286928 A

### SUMMARY OF INVENTION

### Technical Problem

As discussed above, none of the related art documents disclose a method for achieving high curability and excellent heat resistance of a cured product, and do not describe a method for efficiently producing a high quality wafer-level lens.

Accordingly, an object of the present disclosure is to provide a curable composition having excellent curability (particularly, high-speed curability) and capable of forming a cured product that is excellent in heat resistance (particularly, reflow heat resistance).

Another object of the present disclosure is to provide a cured product excellent in productivity and also excellent in heat resistance.

Still another object of the present disclosure is to provide a wafer-level lens excellent in productivity and also excellent in heat resistance, and a method for producing the wafer-level lens.

### Solution to Problem

As a result of intensive studies carried out to solve the above problems, the inventor of the present disclosure has found that a curable composition containing a specific curable component (cationically polymerizable compound) and a specific cationic polymerization initiator as essential components can be rapidly cured to form a cured product having excellent heat resistance, and is suitable as a curable composition for producing a wafer-level lens. The invention of the present disclosure has been completed based on these findings.

That is, the present disclosure provides a curable composition containing components (A) and (B).
Component (A): a compound including an alicyclic epoxy group and including no ester bond.
Component (B): a cationic polymerization initiator including a cation moiety and an anion moiety containing a gallium atom.

In the curable composition of the present disclosure, the compound including the alicyclic epoxy group and including no ester bond in the component (A) may be a compound represented by the formula (a-1).

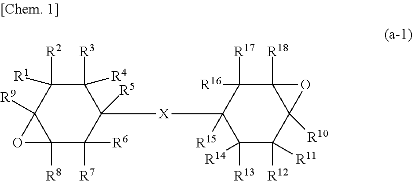

In the formula, R¹ to R¹⁸ are identical to or different from each other and each represent a hydrogen atom, a halogen atom, a hydrocarbon group which may contain an oxygen atom or a halogen atom, or an alkoxy group which may include a substituent. X represents a single bond or a linking group (excluding a linking group containing an ester bond).

In the curable composition of the present disclosure, the anion moiety of the component (B) may be an anion represented by the formula (1).

[Chem. 2]

[(R)ₙGaF₄₋ₙ]⁻ (1)

In formula (1), R represents a monovalent hydrocarbon group or a monovalent fluorohydrocarbon group. n represents an integer of 1 to 4.

In the curable composition of the present disclosure, the anion moiety of the component (B) may be an anion represented by the formula (2).

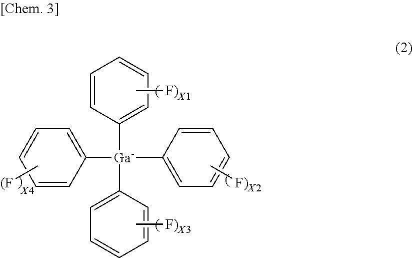

In formula (2), X1 to X4 are identical to or different from each other and each represent an integer of 0 to 5, and the total sum of all of X1 to X4 is 1 or more.

The curable composition of the present disclosure may further contain a component (C).
Component (C): a siloxane compound including two or more epoxy groups in a molecule.

In the curable composition of the present disclosure, at least one of the epoxy groups included in the siloxane compound having two or more epoxy groups in the molecule of the component (C) may be an alicyclic epoxy group.

The curable composition of the present disclosure may further contain a component (D).
Component (D): a hydrogenated glycidyl ether-based epoxy compound.

The curable composition of the present disclosure may be a curable composition for a wafer-level lens.

The present disclosure also provides a cured product of the curable composition.

The present disclosure provides a wafer-level lens containing a cured product of the curable composition.

The present disclosure provides an optical device equipped with the wafer-level lens.

The present disclosure provides a laminated wafer-level lens, which is a laminate of a plurality of wafer-level lenses, and includes at least the wafer-level lens as a wafer-level lens constituting the laminate.

The present disclosure provides an optical device equipped with the laminated wafer-level lens.

The present disclosure provides a method for producing a wafer-level lens, the method including subjecting the curable composition to a casting or injection molding method.

In the method for producing a wafer-level lens of the present disclosure, the casting molding method may include all of 1a, 2a and 3a.
1a: preparing a wafer-level lens mold including one or more lens molds,
2a: bringing the curable composition into contact with the wafer-level lens mold, and
3a: curing the curable composition by heating and/or light irradiation.

In the method for producing a wafer-level lens of the present disclosure, the casting molding method may further include 4a.
4a: annealing the cured curable composition.

In the method for producing a wafer-level lens of the present disclosure, the casting molding method may further include 4a.
5a: cutting the cured curable composition.

In the method for producing a wafer-level lens of the present disclosure, the injection molding method may include all of 1b, 2b, and 3b.
1b: preparing a wafer-level lens mold including one or more lens molds,
2b: injecting the curable composition into the wafer-level lens mold, and
3b: curing the curable composition by heating and/or light irradiation.

In the method for producing a wafer-level lens of the present disclosure, the injection molding method may further include 4b.
4b: annealing the cured curable composition.

The present disclosure provides a method for producing a laminated wafer-level lens including all of 1c, 2c, 3c, 4c, and 5c.
1c: preparing a wafer-level lens mold including one or more lens molds,
2c: bringing the curable composition into contact with the wafer-level lens mold,
3c: curing the curable composition by heating and/or light irradiation to form a wafer-level lens sheet,
4c: laminating a plurality of wafer-level lens sheets including the wafer-level lens sheet described above to form a wafer-level lens sheet laminate, and
5c: cutting the wafer-level lens sheet laminate.

The method for producing a laminated wafer-level lens of the present disclosure may further include 6c between 3c and 4c.
6c: annealing the wafer-level lens sheet.

### Advantageous Effects of Invention

Since the curable composition of the present disclosure has the configuration described above, a cured product excellent in curability and also excellent in heat resistance can be formed. The cured product is excellent in heat resistance, transparency, and the like, and thus can be preferably used as a material for forming a wafer-level lens (a curable composition for a wafer-level lens). Therefore, according to the curable composition of the present disclosure, it is possible to significantly contribute to miniaturization, weight reduction, and performance enhancement of an optical product in which a wafer-level lens is mounted.

In the present specification, the “wafer-level lens” is a lens used when a camera used in a cellular phone or the like is produced at a wafer level, and the size thereof is, for example, about 1 to 10 mm, preferably about 3 to 5 mm in diameter. The thickness thereof is, for example, about 100 to 1500 μm, and preferably 500 to 800 μm.

### DESCRIPTION OF EMBODIMENTS

### Curable Composition

As described above, the curable composition of the present disclosure includes the following component (A) and component (B) as essential components.
Component (A): a compound including an alicyclic epoxy group and including no ester bond.
Component (B): a cationic polymerization initiator including a cation moiety and an anion moiety containing a gallium atom.

The curable composition of the present disclosure may contain components besides those described above, for example, may contain curable components (cationically polymerizable compounds) such as a component (C), component (D), component (E), component (F), and component (G) described below, and other additives.

### Component (A)

The component (A) of the present disclosure is one of the curable components (cationically polymerizable compounds) contained in the curable composition, and is a compound having one or more alicyclic epoxy groups in one molecule and having no ester bond (hereinafter referred to as “alicyclic epoxy compound” in some cases).

In the present specification, the “alicyclic epoxy group” is a group in which two adjacent carbon atoms constituting an alicyclic ring form a ring together with one oxygen atom. The alicyclic epoxy compound is excellent in curability.

As the alicyclic epoxy group, for example, an epoxy group constituted by two adjacent carbon atoms constituting a cyclohexane ring and an oxygen atom, or the like may be cited.

The alicyclic epoxy compound includes one or more (for example, one to six) alicyclic epoxy groups in one molecule; more specifically, the alicyclic epoxy compound preferably includes two to five, particularly, two alicyclic epoxy groups.

Examples of the alicyclic epoxy compound may include compounds represented by the following formula (a-1). In the formula, R¹ to R¹⁸ are identical to or different from each other and each represent a hydrogen atom, a halogen atom, a hydrocarbon group which may contain an oxygen atom or a halogen atom, or an alkoxy group which may include a substituent. X represents a single bond or a linking group (excluding a linking group containing an ester bond).

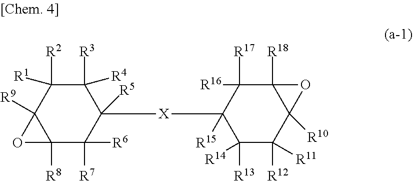

Examples of the halogen atom in R¹ to R¹⁸ may include a fluorine atom, a chlorine atom, a bromine atom, and an iodine atom.

Examples of the hydrocarbon group in R¹ to R¹⁸ may include an aliphatic hydrocarbon group (alkyl group, alkenyl group, alkynyl group, or the like), an alicyclic hydrocarbon group, an aromatic hydrocarbon group, and a group in which two or more of those listed above are bonded.

Examples of the alkyl group may include a C₁₋₂₀ alkyl group (preferably a C₁₋₁₀ alkyl group, particularly preferably a C₁₋₄ alkyl group), such as a methyl group, an ethyl group, a propyl group, an isopropyl group, a butyl group, a hexyl group, an octyl group, an isooctyl group, a decyl group, and a dodecyl group. Examples of the alkenyl group may include a C₂₋₂₀ alkenyl group (preferably a C₂₋₁₀ alkenyl group, particularly preferably a C₂₋₄ alkenyl group), such as a vinyl group, an allyl group, a methallyl group, a 1-propenyl group, an isopropenyl group, a 1-butenyl group, a 2-butenyl group, a 3-butenyl group, a 1-pentenyl group, a 2-pentenyl group, a 3-pentenyl group, a 4-pentenyl group, and a 5-hexenyl group. Examples of the alkynyl group may include a C₂₋₂₀ alkynyl group (preferably a C₂₋₁₀ alkynyl group, particularly preferably a C₂₋₄ alkynyl group), such as an ethynyl group and a propynyl group.

Examples of the alicyclic hydrocarbon group may include a C₃₋₁₂ cycloalkyl group, such as a cyclopropyl group, a cyclobutyl group, a cyclopentyl group, a cyclohexyl group, or a cyclododecyl group; a C₃₋₁₂ cycloalkenyl group, such as a cyclohexenyl group; and a C₄₋₁₅ bridged cyclic hydrocarbon group, such as a bicycloheptanyl group or a bicycloheptenyl group.

Examples of the aromatic hydrocarbon group may include a C₆₋₁₄ aryl group (preferably, a C₆₋₁₀ aryl group), such as a phenyl group or a naphthyl group.

For the group in which two or more groups selected from aliphatic hydrocarbon groups, alicyclic hydrocarbon groups, and aromatic hydrocarbon groups are bonded, examples of the group in which an aliphatic hydrocarbon group and an alicyclic hydrocarbon group are bonded may include a C₃₋₁₂ cycloalkyl-C₁₋₂₀ alkyl group, such as a cyclohexylmethyl group; and a C₁₋₂₀ alkyl-C₃₋₁₂ cycloalkyl group, such as a methylcyclohexyl group. Examples of the group in which an aliphatic hydrocarbon group and an aromatic hydrocarbon group are bonded may include a C₇₋₁₈ aralkyl group (particularly, a C₇₋₁₀ aralkyl group), such as a benzyl group or a phenethyl group; a C₆₋₁₄ aryl-C₂₋₂₀ alkenyl group, such as a cinnamyl group; a C₁₋₂₀ alkyl-substituted C₆₋₁₄ aryl group, such as a tolyl group; and a C₂₋₂₀ alkenyl-substituted C₆₋₁₄ aryl group, such as a styryl group.

Examples of the hydrocarbon group which may contain an oxygen atom or a halogen atom in R¹ to R¹⁸ may include a group in which at least one hydrogen atom in the hydrocarbon group described above is substituted with a group having an oxygen atom or a group having a halogen atom. Examples of the group having the oxygen atom described above may include a hydroxyl group; a hydroperoxy group; a C₁₋₁₀ alkoxy group, such as a methoxy group, an ethoxy group, a propoxy group, an isopropyloxy group, a butoxy group, or an isobutyloxy group; a C₂₋₁₀ alkenyloxy group, such as an allyloxy group; a C₆₋₁₄ aryloxy group (for example, a tolyloxy group or a naphtyloxy group) that may include a substituent selected from a C₁₋₁₀ alkyl group, a C₂₋₁₀ alkenyl group, a halogen atom, and a C₁₋₁₀ alkoxy group; a C₇₋₁₈ aralkyloxy group, such as a benzyloxy group or a phenethyloxy group; a C₁₋₁₀ acyloxy group, such as an acetyloxy, propionyloxy, (meth) acryloyloxy, or benzoyloxy group; a C₁₋₁₀ alkoxycalbonyl group, such as a methoxycarbonyl, ethoxycarbonyl, propoxycarbonyl, or butoxycarbonyl group; a C₆₋₁₄ aryloxycarbonyl group (for example, a phenoxycarbonyl, tolyloxycarbonyl, or naphthyloxycarbonyl group) that may include a substituent selected from a C₁₋₁₀ alkyl group, a C₂₋₁₀ alkenyl group, a halogen atom, and a C₁₋₁₀ alkoxy group; a C₇₋₁₈ aralkyloxycarbonyl group, such as a benzyloxycarbonyl group; an epoxy group-containing group, such as a glycidyloxy group; an oxetanyl group-containing group, such as an ethyloxetanyloxy group; a C₁₋₁₀ acyl group, such as an acetyl, propionyl, or benzoyl group; an isocyanate group; a sulfo group; a carbamoyl group; an oxo group; and a group in which two or more of these groups are bonded via or not via a C₁₋₁₀ alkylene group or the like. Examples of the group including the halogen atom described above may include a fluorine atom, a chlorine atom, a bromine atom, and an iodine atom.

Examples of the alkoxy group in R¹ to R¹⁸ may include a C₁₋₁₀ alkoxy group, such as a methoxy, ethoxy, propoxy, isopropyloxy, butoxy, or isobutyloxy group.

Examples of the substituent that may be included in the alkoxy group may include a halogen atom, a hydroxyl group, a C₁₋₁₀ alkoxy group, a C₂₋₁₀ alkenyloxy group, a C₆₋₁₄ aryloxy group, a C₁₋₁₀ acyloxy group, a mercapto group, a C₁₋₁₀ alkylthio group, a C₂₋₁₀ alkenylthio group, a C₆₋₁₄ arylthio group, a C₇₋₁₈ aralkylthio group, a carboxyl group, a C₁₋₁₀ alkoxycarbonyl group, a C₆₋₁₄ aryloxycarbonyl group, a C₇₋₁₈ aralkyloxycarbonyl group, an amino group, a mono- or di-C₁₋₁₀ alkylamino group, a C₁₋₁₀ acylamino group, an epoxy group-containing group, an oxetanyl group-containing group, a C₁₋₁₀ acyl group, an oxo group, and a group in which two or more of these groups are bonded via or not via a C₁₋₁₀ alkylene group or the like.

In particular, it is preferable for R¹ to R¹⁸ to be hydrogen atoms.

In the formula (a-1), X represents a single bond or a linking group (a bivalent group having one or more atoms). Note that a group containing an ester bond is excluded from the linking group. Examples of the linking group may include a bivalent hydrocarbon group, a carbonyl group, an ether bond, an amide group, and a group in which a plurality of these are linked. Examples of the bivalent hydrocarbon group may include a linear or branched-chain C₁₋₁₈ alkylene group, such as a methylene, methylmethylene, dimethylmethylene, ethylene, propylene, or trimethylene group; and a bivalent C₃₋₁₂ cycloalkylene group and a bivalent C₃₋₁₂ cycloalkylidene group, such as a 1,2-cyclopentylene, 1,3-cyclopentylene, cyclopentylidene, 1,2-cyclohexylene, 1,3-cyclohexylene, 1,4-cyclohexylene, or a cyclohexylidene group.

As a compound represented by the above formula (a-1), 3,4,3′,4′-diepoxybicyclohexyl is particularly preferred from the viewpoint that steric hindrance is small and a curing reaction can be rapidly progressed by light irradiation.

Examples of the alicyclic epoxy compound discussed above may additionally include compounds represented by the following formula (a-2) and formula (a-3).

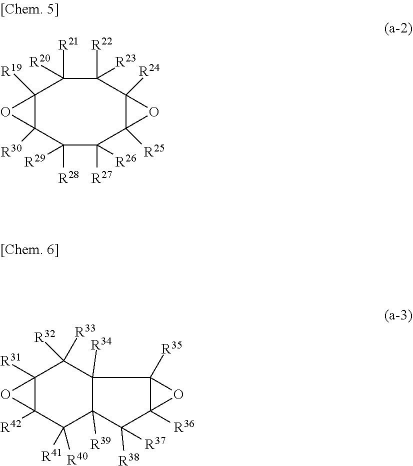

In the formula (a-2), R¹⁹ to R³⁰ each represent a hydrogen atom; a halogen atom; a hydrocarbon group which may contain an oxygen atom or a halogen atom; or an alkoxy group which may include a substituent. R¹⁹ to R³⁰ may be identical to or different from each other. Specific examples of the R¹⁹ to R³⁰ above are similar to those of R¹ to R¹⁸ in the formula (a-1). Among them, as R¹⁹ to R³⁰, a hydrogen atom is preferred, and it is particularly preferable that all of R¹⁹ to R³⁰ be hydrogen atoms.

In the formula (a-3), R³¹ to R⁴² each represent a hydrogen atom; a halogen atom; a hydrocarbon group which may contain an oxygen atom or a halogen atom; or an alkoxy group which may include a substituent. R³¹ to R⁴² may be identical to or different from each other. Specific examples of the above R³¹ to R⁴² are similar to those of R¹ to R¹⁸ in the formula (a-1). Among them, as R³¹ to R⁴², a hydrogen atom is preferred, and it is particularly preferable that all of R³¹ to R⁴² be hydrogen atoms.

In particular, as the alicyclic epoxy compound, a compound represented by the formula (a-1) is preferred.

The alicyclic epoxy compound may be produced, for example, by subjecting a carbon-carbon unsaturated double bond of a corresponding olefin compound (an olefin compound having the same number of carbon-carbon unsaturated double bonds as the number of alicyclic epoxy groups of the alicyclic epoxy compound) to epoxidation. The epoxidation reaction may be carried out by a well-known or commonly used method. As the alicyclic epoxy compound mentioned above, a commercially-available alicyclic epoxy compound may be used.

For example, a compound represented by the formula (a-1) may be produced by subjecting an olefin represented by formula (a-1′) to epoxidation. R¹ to R¹⁸ and X in the formula (a-1′) are identical to R¹ to R¹⁸ and X in the formula (a-1).

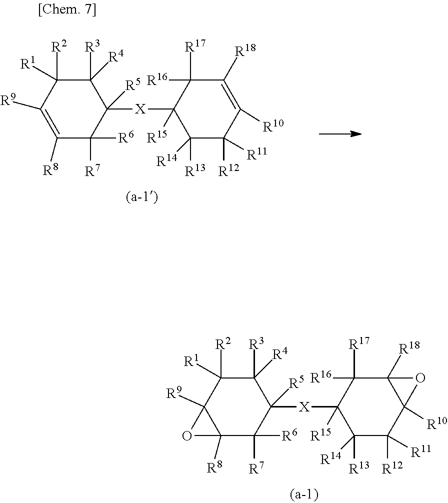

A compound represented by the above formula (a-2) may be produced, for example, by subjecting an olefin (an unsaturated compound having a cyclooctadiene skeleton) represented by formula (a-2′) to oxidation (epoxidation). R¹⁹ to R³⁰ in the formula (a-2′) are identical to those in the formula (a-2).

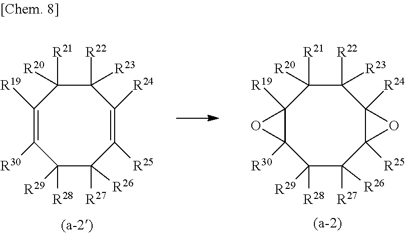

A compound represented by the formula (a-3) may be produced, for example, by subjecting an olefin (an unsaturated compound having a tetrahydroindene skeleton) represented by the formula (a-3′) to oxidation (epoxidation). R³¹ to R⁴² in the formula (a-3′) are identical to those in the formula (a-3).

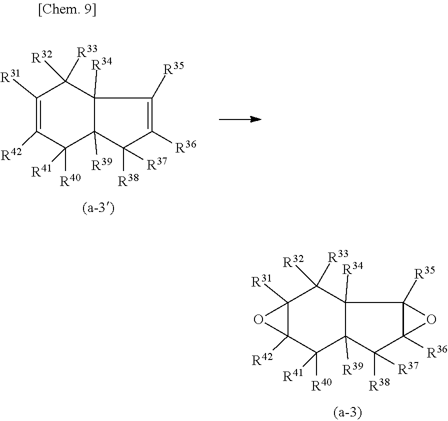

As an epoxidation agent used in the epoxidation reaction, a known or commonly used oxidizing agent (for example, organic percarboxylic acids or hydroperoxides) may be used. Examples of the organic percarboxylic acids may include performic acid, peracetic acid, perpropionic acid, perbenzoic acid, trifluoroperacetic acid, and perphtharic acid. Examples of the hydroperoxides may include hydrogen peroxide, tert-butyl hydroperoxide, and cumene hydroperoxide.

One type of the components (A) may be used alone, or two or more types thereof may be used in combination. As the components (A), compounds represented by the formula (a-1) are preferred in the view of curability of a curable composition, and heat resistance, a low shrinkage ratio and a low linear expansion coefficient of the cured product. Among them, 3,4,3′,4′-diepoxybicyclohexyl, bis(3,4-epoxycyclohexylmethyl) ether, 2,2-bis(3,4-epoxycyclohexyl)propane, 1,2-bis(3,4-epoxycyclohexan-1-yl)ethane, 1,2-epoxy-1,2-bis(3,4-epoxycyclohexan-1-yl)ethane, and bis(3,4-epoxycyclohexyl)methyl are preferred. In particular, it is preferable that 3,4,3′,4′-diepoxybicyclohexyl, bis(3,4-epoxycyclohexylmethyl)ether, and 2,2-bis(3,4-epoxycyclohexyl)propane be essential components from the viewpoint of the curability (particularly high-speed curability) of the curable composition, and the heat resistance (particularly reflow heat resistance) of the cured product.

The content (blended amount) of the components (A) in the curable composition of the present disclosure is not particularly limited, but is preferably from 5 to 70 wt. %, more preferably from 5 to 60 wt. %, further more preferably from 10 to 55 wt. %, and particularly more preferably from 15 to 50 wt. % relative to the curable composition (100 wt. %) of the present disclosure. In a case where the content of the components (A) is outside the above range, it may be difficult to achieve heat resistance and mechanical strength of the cured product in a well-balanced manner.

In particular, the content (blended amount) of the components (A) is not particularly limited, but is preferably from 10 to 70 wt. %, more preferably from 10 to 60 wt. %, further more preferably from 10 to 50 wt. %, and particularly more preferably from 15 to 45 wt. % relative to the total amount (100 wt. %) of the curable components (cationically polymerizable compound) contained in the curable composition of the present disclosure. In a case where the content of the components (A) is less than 10 wt. %, the curability of the curable composition, and the heat resistance (in particular, reflow heat resistance), low shrinkage and low linear expansion of the cured product may be insufficient depending on the mode of use. On the other hand, in a case where the content of the components (A) exceeds 50 wt. %, the mechanical strength of the cured product may be insufficient.

### Component (B)

The cationic polymerization initiator which is the component (B) of the present disclosure is a compound that generates a cationic species by heating or light irradiation to initiate a curing reaction of a cationically polymerizable group (epoxy group, oxetanyl group, vinyl ether group, or the like) of a cationically polymerizable compound containing the component (A), a component (C), a component (D), a component (E), a component (F), a component (G), or the like contained in the curable composition, and is a cationic polymerization initiator including a cation moiety and an anion moiety containing a gallium atom (gallium element). The components (C) to (G) will be described later.

Examples of the cationic polymerization initiator of the component (B) include a photocationic polymerization initiator (photoacid generator) that generates a cationic species by light irradiation (particularly, ultraviolet irradiation) to initiate polymerization, and a thermal cationic polymerization initiator (thermal acid generator) that generates a cationic species by heat treatment to initiate polymerization.

A cation included in a known or commonly used cationic polymerization initiator may be cited as a cation moiety of the cationic polymerization initiator, and examples thereof may include, but are not limited to, an oxonium ion, a sulfonium ion, an iodonium ion, a selenium ion, an ammonium ion, a phosphonium ion, and a transition metal complex ion.

Examples of the oxonium ion include oxonium such as trimethyloxonium, diethylmethyloxonium, triethyloxonium, or tetramethylenemethyloxonium; pyrylium such as 4-methylpyrylium, 2,4,6-trimethylpyrylium, 2,6-di-tert-butylpyrylium, and 2,6-diphenylpyrylium; and chromenium and isochromenium, such as 2,4-dimethylchromenium and 1,3 -dimethylisochromenium.

Examples of the sulfonium ion include: triarylsulfonium such as triphenylsulfonium, tri-p-tolylsulfonium, tri-o-tolylsulfonium, tris(4-methoxyphenyl)sulfonium, 1-naphthyldiphenylsulfonium, 2-naphthyldiphenylsulfonium, tris(4-fluorophenyl)sulfonium, tri-1-naphthylsulfonium, tri-2-naphthylsulfonium, tris(4-hydroxyphenyl)sulfonium, diphenyl[4-(phenylthio)phenyl]sulfonium, 4-(p-tolylthio)phenyldi-p-tolylsulfonium, 4-(4-methoxyphenylthio)phenylbis(4-methoxyphenyl)sulfonium, 4-(phenylthio)phenylbis(4-fluorophenyl)sulfonium, 4-(phenylthio)phenylbis(4-methoxyphenyl)sulfonium, 4-(phenylthio)phenyldi-p-tolylsulfonium, [1,1′-biphenyl]-4-yl[4-(1,1′-biphenyl)-4-ylthiophenyl]phenylsulfonium, [4-(2-thioxsanthonylthio)phenyl]diphenylsulfonium, bis[4-(diphenylsulfonio)phenyl]sulfide, bis[4-{bis[4-(2-hydroxyethoxy)phenyl]sulfonio}phenyl]sulfide, bis{4-[bis(4-fluorophenyl)sulfonio]phenyl}sulfide, bis{4-[bis(4-methylphenyl)sulfonio]phenyl}sulfide, bis{4-[bis(4-methoxyphenyl)sulfonio]phenyl]sulfide, 4-(4-benzoyl-2-chlorophenylthio)phenylbis(4-fluorophenyl)sulfonium, 4-(4-benzoyl-2-chlorophenylthio)phenyldiphenylsulfonium, 4-(4-benzoylphenylthio)phenylbis(4-fluorophenyl)sulfonium, 4-(4-benzoylphenylthio)phenyldiphenylsulfonium, 7-isopropyl-9-oxo-10-thia-9,10-dihydroanthracene-2-yldi-p-tolylsulfonium, 7-isopropyl-9-oxo-10-thia-9,10-dihydroanthracene-2-yldiphenylsulfonium, 2-[(di-p-tolyl)sulfonio]thioxanthone, 2-[(diphenyl)sulfonio]thioxanthone, 4-(9-oxo-9H-thioxanthene-2-yl)thiophenyl-9-oxo-9H-thioxanthene-2-yl phenyl sulfonium, 4-[4-(4-tert-butylbenzoyl)phenylthio]phenyldi-p-tolylsulfonium, 4-[4-(4-(4-tert-butylbenzoyl)phenylthio]phenyldiphenylsulfonium, 4-[4-(benzoylphenylthio)]phenyldi-p-tolylsulfonium, 4-[4-(benzoylphenylthio)]phenyldiphenylsulfonium, 5-(4-methoxyphenyl)thianthrenium, 5-phenylthianthrenium, 5-tolylthianthrenium, 5-(4-ethoxyphenyl)thianthrenium, or 5-(2,4,6-trimethylphenyl)thianthrenium; diarylsulfonium such as diphenylphenacylsulfonium, diphenyl4-nitrophenacylsulfonium, diphenylbenzylsulfonium, or diphenylmethylsulfonium; monoarylsulfonium such as phenylmethylbenzylsulfonium, 4-hydroxyphenylmethylbenzylsulfonium, 4-methoxyphenylmethylbenzylsulfonium, 4-acetocarbonyloxyphenylmethylbenzyl sulfonium, 4-hydroxyphenyl(2-naphthylmethyl)methylsulfonium, 2-naphthylmethylbenzylsulfonium, 2-naphthylmethyl(1-ethoxycarbonyl)ethyl sulfonium, phenylmethylphenacylsulfonium, 4-hydroxyphenylmethylphenacylsulfonium, 4-methoxyphenylmethylphenacylsulfonium, 4-acetocarbonyloxyphenylmethylphenacylsulfonium, 2-naphthylmethylphenacylsulfonium, 2-naphthyloctadecylphenacylsulfonium, or 9-anthracenylmethylphenacylsulfonium; and trialkylsulfonium such as dimethylphenacylsulfonium, phenacyltetrahydrothiophenium, dimethylbenzylsulfonium, benzyltetrahydrothiophenium, or octadecylmethylphenacylsulfonium.

Examples of the iodonium ion include: phenyliodonium, di-p-tolyliodonium, bis(4-dodecylphenyl)iodonium, bis(4-methoxyphenyl)iodonium, (4-octyloxyphenyl)phenyliodonium, bis(4-decyloxy)phenyliodonium, 4-(2-hydroxytetradecyloxy)phenylphenyliodonium, 4-isopropylphenyl(p-tolyl)iodonium, and 4-isobutylphenyl(p-tolyl)iodonium.

Examples of the selenium ion include: triarylselenium such as triphenyl selenium, tri-p-tolyl selenium, tri-o-tolyl selenium, tris(4-methoxyphenyl)selenium, or 1-naphthyldiphenyl selenium; diaryl selenium such as diphenylphenacyl selenium, diphenylbenzyl selenium, or diphenylmethyl selenium; monoarylselenium such as phenylmethylbenzylselenium; and trialkylselenium such as dimethylphenacyl selenium.

Examples of the ammonium ion include: tetraalkyl ammonium such as tetramethylammonium, ethyltrimethylammonium, diethyldimethylammonium, triethylmethylammonium, or tetraethylammonium; pyrrolidinium such as N,N-dimethylpyrrolidinium, N-ethyl-N-methylpyrrolidinium, or N,N-diethylpyrrolidinium; imidazolinium such as N,N′-dimethylimidazolinium, N,N′-diethylimidazolinium, N-ethyl-N′-methylimidazolium, 1,3,4-trimethylimidazolium, or 1,2,3,4-tetramethylimidazolinium; tetrahydropyrimidinium such as N,N′-dimethyltetrahydropyrimidinium; morpholinium such as N,N-dimethylmorpholinium; piperidinium such as N,N′-diethylpiperidinium; pyridinium such as N-methylpyridinium, N-benzylpyridinium, or N-phenacylpyridinium; imidazolium such as N,N′-dimethylimidazolium; quinolium such as N-methylquinolium, N-benzylquinolium, or N-phenacylquinolium; isoquinolium such as N-methylisoquinolium; thiazonium such as benzylbenzothiazonium or phenacylbenzothiazonium; and acridium such as benzylacridium or phenacylacridium.

Examples of the phosphonium ion include: tetraarylphosphonium such as tetraphenylphosphonium, tetra-p-tolylphosphonium, tetrakis(2-methoxyphenyl)phosphonium, tetrakis(3-methoxyphenyl)phosphonium, or tetrakis(4-methoxyphenyl)phosphonium; triarylphosphonium such as triphenylbenzylphosphonium, triphenylphenacylphosphonium, triphenylmethylphosphonium, or triphenylbutylphosphonium; and tetraalkylphosphonium such as triethylbenzylphosphonium, tributylbenzylphosphonium, tetraethylphosphonium, tetrabutylphosphonium, tetrahexylphosphonium, triethylphenacylphosphonium, or tributylphenacylphosphonium.

Examples of the transition metal complex ion include: chromium complex cation such as (η5-cyclopentadienyl)(η6-toluene)Cr⁺ or (η5-cyclopentadienyl)(η6-xylene)Cr⁺; and iron complex cation such as (η5-cyclopentadienyl)(η6-toluene)Fe⁺ or (η5-cyclopentadienyl)(η6-xylene)Fe⁺. The anion moiety of the cationic polymerization initiator as the component (B) may be an anion containing a gallium atom. With the use of a cationic polymerization initiator including an anion moiety containing a gallium atom as the component (B), both curability (particularly, high-speed curability) of the curable composition and heat resistance (particularly, reflow heat resistance) of the cured product may be achieved without using a cationic polymerization initiator containing antimony, which is designated as a substance subject to the control of the Joint Industry Guide (JIG), with a threshold level of 1000 ppm. Since the amount of the uncured component is reduced and the resin decomposition caused by the cationic polymerization initiator is reduced, the weight reduction rate in a high-temperature test may be improved. In addition to excellence in heat resistance, mold-releasability may also be improved.

Examples of the anion containing a gallium atom include: GaF₄⁻ and an anion represented by the following formula (1).

[Chem. 10]

[(R)ₙGaF₄₋ₙ]⁻ (1)

In the above formula (1), R represents a monovalent hydrocarbon group or a monovalent fluorohydrocarbon group. Examples of the monovalent hydrocarbon group include: an aliphatic hydrocarbon group [such as an alkyl group, alkenyl group, or alkynyl group]; an alicyclic hydrocarbon group [such as a cycloalkyl group, cycloalkenyl group, or bridged cyclic hydrocarbon group]; an aromatic hydrocarbon group [such as an aryl group, for example, a phenyl group or naphthyl group]; and a monovalent hydrocarbon group [such as a cycloalkyl-alkyl group, aralkyl group, or alkyl-substituted aryl group (such as a tolyl group)] formed by linking two or more of an aliphatic hydrocarbon group, alicyclic hydrocarbon group, and an aromatic hydrocarbon group. Examples of the monovalent fluorohydrocarbon group include a group in which some or all of the hydrogen atoms in the aforementioned monovalent hydrocarbon group are substituted with fluorine atoms, and specific examples thereof include a fluoroalkyl group, fluoroaryl group, and fluoroalkyl group-substituted aryl group. when n is an integer of 2 or more, a plurality of Rs may be identical to or different from each other.

In the above formula (1), n represents an integer of 1 to 4. Among them, n is preferably an integer of 2 to 4, and more preferably 3 or 4.

More specific examples of the anion moiety include: GaF₄⁻, [Ga(C₆H₅]₄]⁻, [(C₆H₅)Ga(C₆F₅)₃]⁻, and [(C₆H₅)Ga(C₆H₃(CF₃)₂)₃]⁻ [=phenyltris(trifluoromethyl)phenylgallate].

Among them, as the anion moiety, an anion containing a fluorine atom together with a gallium atom [specifically, for example, the GaF₄⁻ described above, a compound represented by the formula (1) where at least one (preferably 2 to 4, more preferably 3 or 4) of Rs is a monovalent fluorohydrocarbon group, or the like] is preferable, and an anion represented by the following formula (2) is more preferable.

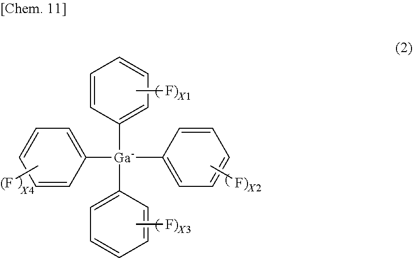

In the formula (2), X1 to X4 (X1, X2, X3, and X4) are identical to or different from each other and each represent an integer of 0 to 5, and the total sum of all of (X1 to X4) is 1 or more.

As the anion moiety, in particular, an anion represented by the formula (2) is preferred, and [Ga(C₆F₅)₄]⁻[=tetrakis(pentafluorophenyl)gallate] is more preferred.

As the cationic polymerization initiator as the component (B), specifically, for example, diphenyl[4-(phenylthiophenyl)]sulfonium tetrakis(pentafluorophenyl)gallate, [1,1′-biphenyl]-4-yl[4-(1,1′-biphenyl)-4-ylthiophenyl] phenylsulfonium tetrakis(pentafluorophenyl)gallate, and benzylmethyl p-hydroxyphenylsulfonium tetrakis(pentafluorophenyl)gallate may be preferably used.

One type of the cationic polymerization initiator as the component (B) may be used alone, or two or more types thereof may be used in combination. The cationic polymerization initiator as the component (B) may be produced by a known or commonly used method (for example, a method described in JP 2017-048325 A). A commercially available product as well may be used as the component (B).

The content of the component (B) is, for example, approximately 0.01 to 10 parts by weight relative to the total 100 parts by weight of the curable components (the cationically polymerizable compound containing the component (A), component (C), component (D), component (E), component (F), and component (G), and the like, and components (C) to (G) are described below) contained in the curable composition of the present disclosure; the lower limit value thereof is preferably 0.03 parts by weight or greater, more preferably 0.05 parts by weight or greater, further more preferably 0.07 parts by weight or greater, and particularly preferably 0.1 parts by weight or greater; the upper limit value is preferably 7 parts by weight or less, more preferably 5 parts by weight or less, further more preferably 3 parts by weight or less, and particularly preferably 1 part by weight or less. When the content of the component (B) is less than the range described above, the curability is likely to be degraded. On the other hand, when the content of the component (B) exceeds the range described above, the preservation stability of the composition is likely to be degraded.

The curable composition of the present disclosure may include a cationically curable compound besides the component (A). Examples of the cationically curable compound besides the component (A) include, but are not limited to, the following components (C), (D), (E), (F), and (G).
Component (C): a siloxane compound including two or more epoxy groups in a molecule
Component (D): a hydrogenated glycidyl ether-based epoxy compound
Component (E): a compound including an alicyclic epoxy group and an ester bond
Component (F): an oxetane compound
Component (G): an aromatic glycidyl ether-based epoxy compound

When the curable composition of the present disclosure contains a cationically curable compound besides the component (A), the viscosity of the curable composition may be controlled and handleability may be improved, curing shrinkage may be suppressed when a cured product is formed, or the like. In the curable composition of the present disclosure, one type of the cationically curable compound besides the composition (A) may be used alone, or two or more types thereof may be used in combination.

### Component (C)

The component (C) is a compound that includes two or more epoxy groups in the molecule, and at least includes a siloxane skeleton including a siloxane bond (Si—O—Si). When the curable composition of the present disclosure includes the component (C), the cured product may have heat resistance and mechanical strength in a well-balanced manner.

Examples of the siloxane skeleton in the component (C) include, but are not limited to, a cyclic siloxane skeleton; and a polysiloxane skeleton such as linear or branched-chain silicone (linear or branched-chain polysiloxane), or cage or ladder polysilsesquioxane. Among them, as the siloxane skeleton, the cyclic siloxane skeleton is preferred from the viewpoint of curability of the curable composition and heat resistance and mechanical strength of the cured product. That is, the cyclic siloxane including two or more epoxy groups in the molecule is preferred as the component (C).

When the component (C) is cyclic siloxane including two or more epoxy groups, the number of Si—O units forming the siloxane ring (the number is equal to the number of silicon atoms forming the siloxane ring) is not particularly limited, but is preferably from 2 to 12 and more preferably from 4 to 8 in the view of curability of the curable composition and heat resistance and mechanical strength of the cured product.

The number of epoxy groups included in the molecule of the component (C) is not particularly limited as long as it is two or more, but is preferably 2 to 4, and more preferably 3 to 4 from the viewpoint of curability of the curable composition and heat resistance and mechanical strength of the cured product.

Epoxy equivalence (in accordance with JIS K7236) of the component (C) is not particularly limited, but is preferably 180 to 400, more preferably 240 to 400, and further more preferably 240 to 350 from the viewpoint of curability of the curable composition and heat resistance and mechanical strength of the cured product.

The epoxy group in the component (C) is not particularly limited, but from the viewpoint of curability of the curable composition, at least one (preferably two or more, more preferably all) of the epoxy groups is preferably an epoxy group including two adjacent carbon atoms and an oxygen atom constituting an aliphatic ring (alicyclic epoxy group), and particularly preferably at least one (preferably two or more, more preferably all) of the epoxy groups is a cyclohexene oxide group (an epoxy group including two adjacent carbon atoms and an oxygen atom constituting a cyclohexane ring).

It is also preferable that at least one (preferably two or more, more preferably all) of the epoxy groups in the component (C) is a glycidyl group from the viewpoint of imparting yellowing resistance (heat-resistant transparency) to the cured product when exposed to a high-temperature environment over a long period of time.

Examples of the component (C) include a compound (cyclic siloxane) represented by the following formula (3).

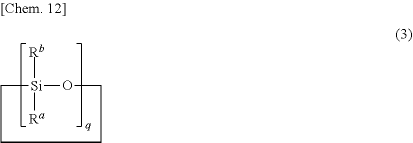

In the formula (3), R^{a}s and R^{b}s each represent a monovalent group containing an epoxy group, or an alkyl group. However, at least two of R^{a}s and R^{b}s in the compound represented by the formula (3) are monovalent groups containing epoxy groups. Examples of the monovalent group containing an epoxy group include, but are not limited to, a monovalent group containing an alicyclic epoxy group and a monovalent group containing a glycidyl group. Note that q in the formula (3) represents an integer of 3 or more (preferably an integer of 3 to 6). R^{a}s and R^{b}s in the compound represented by the formula (3) may be identical to or different from each other. A plurality of R^{a}s may be identical to or different from each other, and a plurality of R^{b}s may also be identical to or different from each other.

Examples of the monovalent group containing an alicyclic epoxy group include, but are not limited to, a group represented by -A-R^{c} [A represents an alkylene group and R^{c} represents an alicyclic epoxy group]. Examples of A (alkylene group) mentioned above include a linear or branched-chain alkylene group having from 1 to 18 carbons, such as a methylene group, a methylmethylene group, a dimethylmethylene group, an ethylene group, a propylene group, or a trimethylene group. Examples of R^{c} discussed above include a cyclohexene oxide group.

The monovalent group containing a glycidyl group is preferably a glycidyl ether group represented by —B—O—R^{d} [B represents an alkylene group and R^{d} represents a glycidyl group]. Examples of B (alkylene group) mentioned above may include a linear or branched-chain alkylene group having from 1 to 18 carbons, such as a methylene group, a methylmethylene group, a dimethylmethylene group, a dimethylene group, or a trimethylene group.

Examples of the alkyl group may include a linear or branched-chain alkyl group having from 1 to 18 (preferably from 1 to 6, particularly preferably from 1 to 3) carbons, such as a methyl group, an ethyl group, a propyl group, or an isopropyl group.

Note that q in the formula (3) represents an integer of 3 or more; in particular, an integer of 3 to 6 is preferred in terms of excellent curability of the curable composition and excellent heat resistance and mechanical strength of the cured product.

More specifically, examples of the component (C) include 1,3-bis(3,4-epoxycyclohexyl)ethyl-1,1,3,3-tetramethyldisiloxane, 2,4-di[2-(3-{oxabicyclo[4.1.0]heptyl})ethyl]-2,4,6,6,8,8-hexamethyl-cyclotetrasiloxane, 4,8-di[2-(3-{oxabicyclo[4.1.0]heptyl})ethyl]-2,2,4,6,6,8-hexamethyl-cyclotetrasiloxane, 2,4-di[2-(3-{oxabicyclo[4.1.0]heptyl})ethyl]-6,8-dipropyl-2,4,6,8-tetramethyl-cyclotetrasiloxane, 4,8-di[2-(3-{oxabicyclo[4.1.0]heptyl})ethyl]-2,6-dipropyl-2,4,6,8-tetramethyl-cyclotetrasiloxane, 2,4,8 -tri [2-(3-{oxabicyclo[4.1.0]heptyl})ethyl]-2,4,6,6,8-pentamethyl-cyclotetrasiloxane, 2,4,8-tri[2-(3-{oxabicyclo[4.1.0]heptyl})ethyl]-6-propyl-2,4,6, 8-tetramethyl-cyclotetrasiloxane, 2,4,6,8-tetra[2-(3-{oxabicyclo[4.1.0]heptyl})ethyl]-2,4,6,8-tetramethyl-cyclotetrasiloxane, and a silsesquioxane including an epoxy group. Even more specifically, the examples include cyclic siloxane having two or more alicyclic epoxy groups in the molecule represented by the following formula.

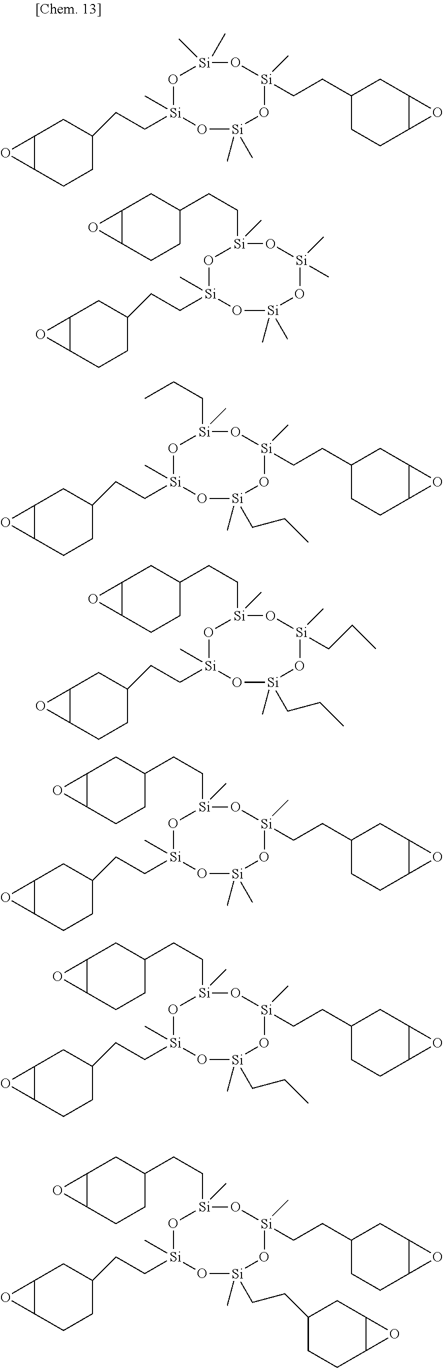

Specific examples of the component (C) may include cyclic siloxane having two or more glycidyl groups in the molecule represented by the following formula.

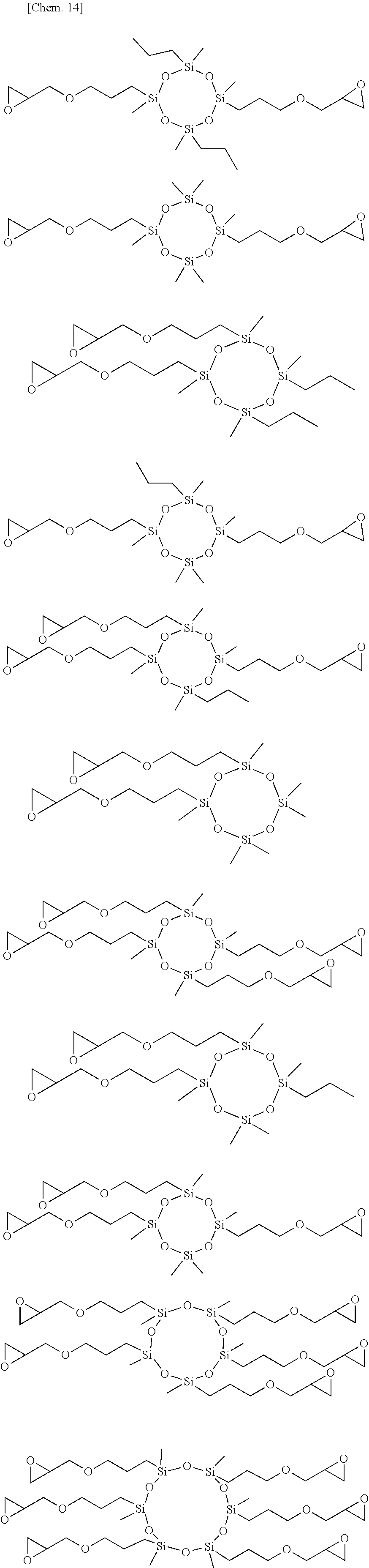

As the component (C), for example, an alicyclic epoxy group-containing silicone resin described in JP 2008-248169 A or an organopolysilsesquioxane resin having at least two epoxy functional groups in one molecule described in JP 2008-19422 A may also be used.

In the curable composition of the present disclosure, one type of the component (C) may be used alone, or two or more types thereof may be used in combination. As the components (C), commercially available products such as trade name “X-40-2678” (available from Shin-Etsu Chemical Co., Ltd.), trade name “X-40-2720” (available from Shin-Etsu Chemical Co., Ltd.), trade name “RK-470” (available from Shin-Etsu Chemical Co., Ltd.), trade name “ X-40-2701” (available from Shin-Etsu Chemical Co., Ltd.), trade name “X-40-2728” (available from Shin-Etsu Chemical Co., Ltd.), trade name “X-40-2738” (available from Shin-Etsu Chemical Co., Ltd.), and trade name “X-40-2740” (available from Shin-Etsu Chemical Co., Ltd.) may also be used.

When the curable composition of the present disclosure contains the component (C), the content (blended amount) thereof is not particularly limited, but is preferably from 1 to 50 wt. %, more preferably from 5 to 45 wt. %, and even more preferably from 10 to 40 wt. %, relative to the curable composition (100 wt. %) of the present disclosure. In a case where the content of the components (C) is outside the above range, it may be difficult to achieve heat resistance and mechanical strength of the cured product in a well-balanced manner.

When the curable composition of the present disclosure includes the component (C), the content (blended amount) of the component (C) relative to the total amount (100 wt. %) of the curable components (the cationically polymerizable compound containing the components (A), (C), (D), (E), (F) and (G), and the like) included in the curable composition is not particularly limited, but is preferably from 1 to 60 wt. %, more preferably from 5 to 55 wt. %, and even more preferably from 10 to 50 wt. %. In a case where the content of the components (C) is outside the above range, it may be difficult to achieve heat resistance and mechanical strength of the cured product in a well-balanced manner.

### Component (D)

The component (D) is a hydrogenated glycidyl ether-based epoxy compound (nucleus hydrogenated aromatic glycidyl ether-based epoxy compound) formed by subjecting an aromatic ring of the component (G) (aromatic glycidyl ether-based epoxy compound) to hydrogenation. The component (G) is to be described later. When the curable composition of the present disclosure includes the component (D), transparency, heat resistance, and mechanical strength of the cured product may be well-balanced.

Examples of the component (D) may include: a compound (hydrogenated bisphenol A type epoxy compound) formed by hydrogenating a bisphenol A type epoxy compound, such as 2,2-bis[4-(2,3-epoxypropoxy)cyclohexyl]propane, 2,2-bis[3,5-dimethyl-4-(2,3-epoxypropoxy)cyclohexyl]propane, or a polymer of these compounds; a compound (hydrogenated bisphenol F type epoxy compound) formed by hydrogenating a bisphenol F type epoxy compound, such as bis[o,o-(2,3-epoxypropoxy)cyclohexyl]methane, bis[o,p-(2,3-epoxypropoxy)cyclohexyl]methane, bis[p,p-(2,3-epoxypropoxy)cyclohexyl]methane, bis[3,5-dimethyl-4-(2,3-epoxypropoxy)cyclohexyl]methane, or a polymer of these compounds; a hydrogenated biphenol type epoxy compound; a hydrogenated phenol novolac type epoxy compound; a hydrogenated cresol novolac type epoxy compound; a hydrogenated cresol novolac type epoxy compound of bisphenol A; a hydrogenated naphthalene type epoxy compound; and a hydrogenated epoxy compound of an epoxy compound obtained from trisphenolmethane. Among them, an epoxy compound formed by hydrogenating a bisphenol A type epoxy compound is particularly preferable.

In the curable composition of the present disclosure, one type of the component (D) may be used alone, or two or more types thereof may be used in combination. As the component (D), a commercially available product may be used, and for example, trade name “YX8000” (available from Mitsubishi Chemical Corporation) is available.

When the curable composition of the present disclosure includes the component (D), the content (blended amount) of the component (D) is not particularly limited, but is preferably from 5 to 40 wt. % and more preferably from 10 to 30 wt. % relative to the total amount (100 wt. %) of the curable components (the cationically polymerizable compound containing the components (A), (C), (D), (E), (F) and (G), and the like) contained in the curable composition of the present disclosure. In a case where the content of the component (D) is not less than 5 wt. %, the mechanical strength of the cured product may be enhanced. On the other hand, in a case where the content of the component (D) exceeds 40 wt. %, the curability of the curable composition may become poor depending on the mode of use. Component (E)

Specific examples of the “compound including an alicyclic epoxy group and an ester bond” as the component (E) may include a compound represented by the following formula (a-5).

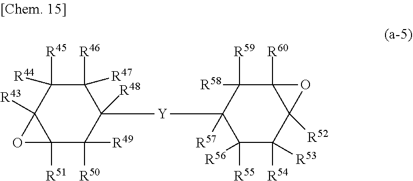

In the above formula (a-5), R⁴³ to R⁶° each represent a hydrogen atom; a halogen atom; a hydrocarbon group which may contain an oxygen atom or a halogen atom; or an alkoxy group which may include a substituent. R⁴³ to R⁶° may be identical to or different from each other. Specific examples of R⁴³ to R⁶° mentioned above are similar to those of R¹ to R¹⁸ in the formula (a-1). Among them, as R⁴³ to R⁶⁰, a hydrogen atom is preferable, and it is particularly preferable that all of R⁴³ to R⁶⁰ be hydrogen atoms.

Y in the above formula (a-5) represents a linking group containing an ester bond (a bivalent group containing one or more atoms). Examples of the linking group containing an ester bond include an ester group (ester bond itself); and a group (bivalent group containing an ester bond) in which one or more linking groups (bivalent groups having one or more atoms) are linked to each other via one or more ester bonds, and the linking groups include a bivalent hydrocarbon group, a carbonyl group, an ether bond, an amide group, and a group in which a plurality of these groups are linked to each other.

Specific examples of the compounds represented by the formula (a-5) may include compounds represented by the following formulae (a-5-1) to (a-5-7). In the formula (a-5-4) below, m represents an integer of 1 to 30. In the formulae (a-5-6) and (a-5-7) below, n1 to n6 each represent an integer of 1 to 30.

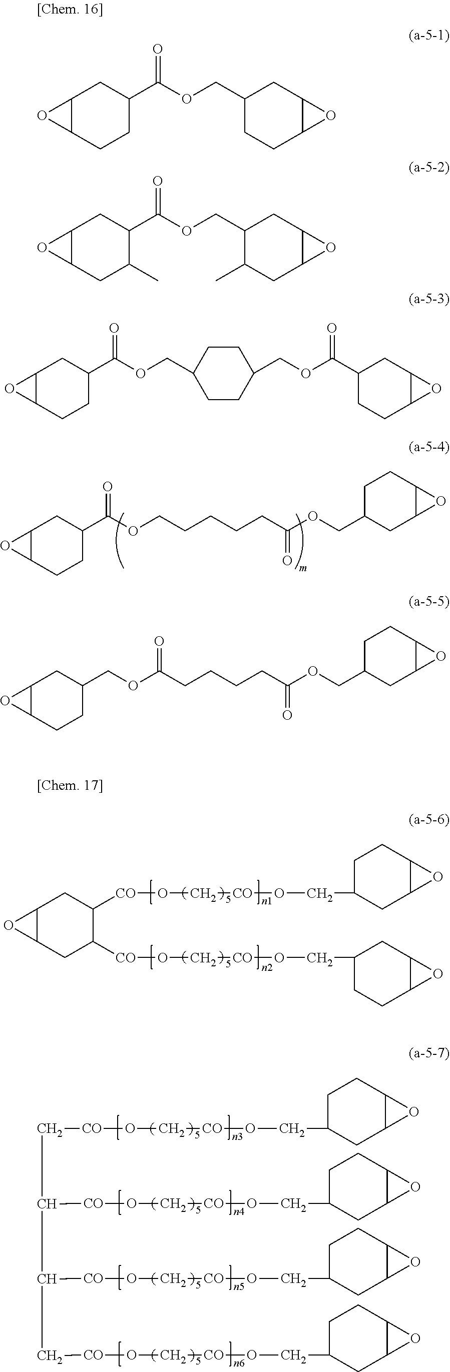

In the curable composition of the present disclosure, one type of the component (E) may be used alone, or two or more types thereof may be used in combination. As the component (E), a commercially available product such as trade name “CELLOXIDE 2021P” (available from Daicel Corporation) may also be used.

When the curable composition of the present disclosure contains the component (E), the content (blended amount) thereof is not particularly limited, but is preferably not greater than 60 parts by weight, more preferably not greater than 50 parts by weight, and most preferably not greater than 40 parts by weight relative to 100 parts by weight of the component (A) and the like. In a case where the content of the component (E) exceeds the above range, the curability is likely to deteriorate and the heat resistance of the resultant cured product is likely to deteriorate. In addition, since an epoxy compound containing an ester bond in the molecule is easily hydrolyzed, water resistance of the resultant cured product is likely to deteriorate.

When the curable composition of the present disclosure includes the component (E), the content (blended amount) of the component (E) is not particularly limited, but is preferably not greater than 30 wt. % (for example, from 0 to 30 wt. %), more preferably not greater than 25 wt. %, further more preferably not greater than 20 wt. %, and particularly preferably not greater than 15 wt. % relative to the total amount (100 wt. %) of the curable components (the cationically polymerizable compound containing the components (A), (C), (D), (E), (F) and (G), and the like). In a case where the content exceeds the above range, the curability of the curable composition may be insufficient depending on the shape, thickness, and the like of the cured product.

In particular, when the curable composition of the present disclosure includes the component (E), it is preferable that the content (part by weight) of the component (A) and the content of the component (E) satisfy the following formula relationship (the content of the component (A) is larger than the content of the component (E)).

### Component (A)>Component (E)

In other words, a difference in content between the component (A) and the component (E) ([the content (part by weight) of the component (A)]−[the content (part by weight) of the component (E)]) is preferably greater than 0 part by weight, more preferably not less than 5 parts by weight, and further more preferably not less than 10 parts by weight. When the difference is not greater than 0 part by weight, the curability of the curable composition may be deteriorated, and the curing failure may easily occur.

### Component (F)

The component (F) is a compound (oxetane compound) including one or more oxetanyl groups in the molecule. When the curable composition of the present disclosure includes the component (F), transparency, heat resistance, and mechanical strength of the cured product may be achieved in a well-balanced manner.

Examples of the component (F) may include 3,3-bis(vinyloxymethyl)oxetane, 3-ethyl-3-hydroxymethyloxetane, 3-ethyl-3-(2-ethylhexyloxymethyl)oxetane, 3-ethyl-3-(hydroxymethyl)oxetane, 3-ethyl-3-[(phenoxy)methyl]oxetane, 3-ethyl-3-(hexyloxymethyl)oxetane, 3-ethyl-3-(chloromethyl)oxetane, 3,3-bis(chloromethyl)oxetane, 1,4-bis[(3-ethyl-3-oxetanylmethoxy)methyl]benzene, bis([1-ethyl(3-oxetanyl)]methyl)ether, 4,4′-bis[(3-ethyl-3-oxetanyl)methoxymethyl]bicyclohexyl, 1,4-bis[(3-ethyl-3-oxetanyl)methoxymethyl]cyclohexane, 1,4-bis([(3-ethyl-3-oxetanyl)methoxy]methyl)benzene, 3-ethyl-3([(3-ethyloxetane-3-yl)methoxy]methyl)oxetane, and xylylenebisoxetane.

In the curable composition of the present disclosure, one type of the component (F) may be used alone, or two or more types thereof may be used in combination. As the component (F), for example, commercially available products such as trade name “ARON OXETANE OXT221” and trade name “ARON OXETANE OXT121” (available from Toa Gosei Co., Ltd.) may be used.

When the curable composition of the present disclosure includes the component (F), the content (blended amount) of the component (F) is not particularly limited, but is preferably from 5 to 40 wt. %, more preferably from 5 to 30 wt. %, and further more preferably from 5 to 20 wt. % relative to the total amount (100 wt. %) of the curable components (the cationically polymerizable compound containing the components (A), (C), (D), (E), (F) and (G), and the like) contained in the curable composition of the present disclosure. When the content of the component (F) is not less than 5 wt. %, the curability (particularly, the curability when cured by ultraviolet irradiation) may be further improved. On the other hand, in a case where the content of the oxetane compound exceeds 30 wt. %, the heat resistance of the cured product may be poor depending on the mode of use.

### Component (G)

Examples of the aromatic glycidyl ether-based epoxy compound in the component (G) include a naphthalene type epoxy resin, an epoxy resin formed from trisphenolmethane, and a fluorene type epoxy resin, such as a bisphenol A type epoxy resin, a biphenol F type epoxy resin, a biphenol type epoxy resin, and a novolac type epoxy resin (for example, a phenol novolac type epoxy resin, a cresol novolac type epoxy resin, or a bisphenol A cresol novolac type epoxy resin). Among them, a bisphenol A type epoxy compound is particularly preferred.

In the curable composition of the present disclosure, one type of the component (G) may be used alone, or two or more types thereof may be used in combination. As the component (G), a commercially available product may be used, and for example, trade name “jER827” (available from Mitsubishi Chemical Corporation) is available.

When the curable composition of the present disclosure includes the component (G), the content (blended amount) of the component (G) is not particularly limited, but is preferably from 5 to 50 wt. % and more preferably from 5 to 40 wt. % relative to the total amount (100 wt. %) of the curable components (the cationically polymerizable compound containing the components (A), (C), (D), (E), (F), and (G)) contained in the curable composition of the present disclosure. When the content of the component (G) is not less than 5 wt. %, the curability (particularly, the curability when cured by ultraviolet irradiation) may be further improved. On the other hand, in a case where the content of the component (G) exceeds 30 wt. %, the heat resistance of the cured product may be poor depending on the mode of use.

### Other Cationically Polymerizable Compounds

The curable composition of the present disclosure may include cationically polymerizable compounds besides the components (A), (C), (D), (E), (F), and (G) (referred to as “other cationically curable compounds” in some cases). Examples of the other cationically curable compounds include epoxy compounds besides the components (A), (C), (D), (E), (F), and (G) (referred to as “other epoxy compounds” in some cases), and vinyl ether compounds. In the curable composition of the present disclosure, one type of the other cationically curable compounds may be used alone, or two or more types thereof may be used in combination.

Examples of the other epoxy compounds include a compound in which an epoxy group is directly bonded to an alicycle via a single bond (for example, a compound represented by the following formula (a-4)); an aliphatic glycidyl ether-based epoxy compound such as a mono or polyglycidyl ether of aliphatic polyhydric alcohol; a glycidyl ester-based epoxy compound; and a glycidyl amine-based epoxy compound.

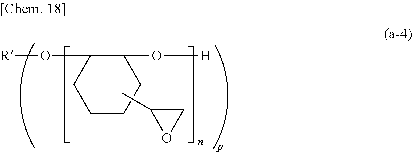

In the formula (a-4), R′ represents a group in which p pieces of —OH are removed from a structural formula of p-hydric alcohol. Each of p and n represents a natural number. Here, p is preferably from 1 to 6, and n is preferably from 1 to 30. Examples of the p-hydric alcohol [R′—OH)ₚ] include polyhydric alcohol having from 1 to 15 carbons, such as 2,2-bis(hydroxymethyl)-1-butanol. When p is 2 or greater, n for each group indicated within the outermost parentheses may be identical to or different from each other. As the compound represented by the above formula (a-4), a 1,2-epoxy-4-(2-oxiranyl)cyclohexane adduct of 2,2-bis(hydroxymethyl)-1-butanol [for example, trade name “EHPE3150”, available from Daicel Corporation] or the like may be suitably used.

A compound having at least one vinyl ether group in the molecule sufficiently serves as the vinyl ether compound, and examples thereof include: 2-hydroxyethyl vinyl ether, 3-hydroxypropyl vinyl ether, 2-hydroxypropyl vinyl ether, 2-hydroxyisopropyl vinyl ether, 4-hydroxybutyl vinyl ether, 3-hydroxybutyl vinyl ether, 2-hydroxybutyl vinyl ether, 3-hydroxyisobutyl vinyl ether, 2-hydroxyisobutyl vinyl ether, 1-methyl-3-hydroxypropyl vinyl ether, 1-methyl-2-hydroxypropyl vinyl ether, 1-hydroxymethylpropyl vinyl ether, 4-hydroxycyclohexyl vinyl ether, 1,6-hexanediol mono or divinyl ether, 1,4-cyclohexane dimethanol mono or divinyl ether, 1,3-cyclohexane dimethanol mono or divinyl ether, 1,2-cyclohexane dimethanol mono or divinyl ether, p-xylene glycol mono or divinyl ether, m-xylene glycol mono or divinyl ether, o-xylene glycol mono or divinyl ether, diethylene glycol mono or divinyl ether, triethylene glycol mono or divinyl ether, tetraethylene glycol mono or divinyl ether, pentaethylene glycol mono or divinyl ether, oligoethylene glycol mono or divinyl ether, polyethylene glycol mono or divinyl ether, dipropylene glycol mono or divinyl ether, tripropylene glycol mono or divinyl ether, tetrapropylene glycol mono or divinyl ether, pentapropylene glycol mono or divinyl ether, oligopropylene glycol mono or divinyl ether, polypropylene glycol mono or divinyl ether, and derivatives thereof.

The content (blended amount) of the other cationically curable compounds is not particularly limited, but is preferably from 0 to 50 wt. % (for example, from 5 to 50 wt. %), more preferably from 0 to 30 wt. % (for example, from 5 to 30 wt. %), and further more preferably from 0 to 15 wt. % relative to the curable composition (100 wt. %) of the present disclosure.

### Mold-Releasing Agent

The curable composition of the present disclosure may contain a mold-releasing agent. Inclusion of a mold-releasing agent facilitates demolding from a wafer-level lens mold, for example. As the mold-releasing agent, although not particularly limited, a known or commonly used mold-releasing agent such as a fluorine compound (fluorine-based mold-releasing agent; fluororesin, fluoroalkyl group-containing compound, or the like), a silicone compound (silicone-based mold-releasing agent; silicone oil, silicone resin, or the like), wax (polyethylene wax, polypropylene wax, or the like), a long-chain carboxylic acid, a long-chain carboxylic acid metal salt, or polyhydric alcohol (polyethylene glycol or the like) may be used. Among them, preferred is a mold-releasing agent including a cationically curable functional group such as an epoxy group or an oxetanyl group in the molecule (for example, a fluorine compound having a cationically curable functional group or a silicone compound having a cationically curable functional group). One type of the mold-releasing agent may be used alone, or two or more types thereof may be used in combination. As the mold-releasing agent, for example, a commercially available product such as trade name “E-1630” (available from Daicel Corporation) may also be used. The content of the mold-releasing agent can be appropriately set in accordance with the type of the mold-releasing agent, the molding method, and the like and is not particularly limited, but is preferably from 0.1 to 10 wt. % and more preferably from 0.5 to 5 wt. % relative to the curable composition (100 wt. %) of the present disclosure.

### Other Components Such as Additives

The curable composition of the present disclosure may contain other components such as an additive. As the additive, although not specifically limited, a known or commonly-used additive is cited, and examples thereof include: metal oxide particles, rubber particles, a silicone-based or fluorine-based defoaming agent, a silane coupling agent, a filler, a plasticizer, a leveling agent, an antistatic agent, a flame retardant, colorant, an antioxidant, an ultraviolet absorbing agent, an ion adsorbing body, and pigment. The content (blended amount) of these various additives is not particularly limited, but is preferably not greater than 5 wt. % relative to the curable composition (100 wt. %) of the present disclosure. The curable composition of the present disclosure may contain a solvent, but when the curable composition contains the solvent in an excessive amount, the cured product may include bubbles. Therefore, the content thereof is preferably not greater than 10 wt. % and more preferably not greater than 1 wt. % relative to the curable composition (100 wt. %) of the present disclosure.

The curable composition of the present disclosure preferably excludes a composition containing a monoallyl diglycidyl isocyanurate compound represented by the following formula (4). When the curable composition of the present disclosure contains a monoallyl diglycidyl isocyanurate compound represented by the following formula (4), curability is likely to be poor, and it may be difficult to obtain a cured product without tack. In addition, the produced cured product tends to have deficiencies such as warpage. In the formula (4) below, R^{c}s and R^{f} are identical or different, and each represent a hydrogen atom or an alkyl group having from 1 to 8 carbons; examples of the alkyl group having from 1 to 8 carbons include: a linear or branched-chain alkyl group, such as a methyl group, an ethyl group, a propyl group, an isopropyl group, a butyl group, an isobutyl group, an s-butyl group, a pentyl group, a hexyl group, a heptyl group, or an octyl group.

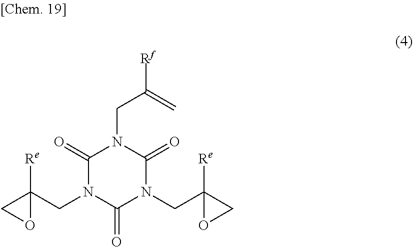

The curable composition of the present disclosure may be prepared, although not particularly limited, in the following manner: for example, predetermined quantities of the components (A) and (B), and optionally the components (C), (D), (E), (F) and (G), and other cationically polymerizable compounds, additives, and the like are blended, and stirred and mixed as necessary while removing air bubbles under vacuum, for example. The temperature during stirring and mixing is preferably approximately from 10 to 60° C. For stirring and mixing, a known or commonly used device, such as a planetary centrifugal mixer, a single-axis or multi-axis extruder, a planetary mixer, a kneader, or a dissolver may be used.

When the curable composition of the present disclosure is cured, a cured product (referred to as the “cured product of the present disclosure” in some cases) is obtained. Curing (curing reaction) of the curable composition of the present disclosure may proceed by, for example, heat treatment and/or light irradiation. When heat treatment is performed, the temperature thereof can be adjusted as appropriate depending on the components subjected to the reaction, the type of the catalyst and the like, and is not particularly limited but is preferably from 100 to 200° C. and more preferably from 120 to 160° C. When light irradiation is performed, as the light source thereof, for example, a mercury lamp, a xenon lamp, a carbon arc lamp, a metal halide lamp, sunlight, an electron beam source, or a laser light source may be used. After the light irradiation, for example, the curable composition may be subjected to heat treatment at a temperature of about 50 to 180° C. to undergo the further curing reaction.

After completion of the heat treatment and/or light irradiation, it is preferable to further perform annealing treatment to remove an internal strain. For example, it is preferable to perform heating at a temperature of 100 to 200° C. for about 30 minutes to 1 hour.

The internal transmittance of the cured product of the present disclosure at 400 nm [in terms of a thickness of 0.5 mm] is not particularly limited, but is preferably 70% or greater (for example, 70 to 100%), more preferably 75% or greater, further more preferably 80% or greater, and particularly preferably 85% or greater. The refractive index of the cured product of the present disclosure is not particularly limited, but is preferably 1.45 or greater and more preferably 1.50 or greater. The Abbe number of the cured product of the present disclosure is not particularly limited, but is preferably 45 or greater and more preferably 50 or greater.

The glass-transition temperature (Tg) of the cured product of the present disclosure is not particularly limited, but is preferably 100° C. or higher (for example, 100 to 200° C.) and more preferably 140° C. or higher. When the glass-transition temperature is below 100° C., the heat resistance of the cured product may become insufficient depending on the mode of use. The glass-transition temperature of the cured product may be measured by, for example, various thermal analyses [a differential scanning calorimeter (DSC), a thermomechanical analyzer (TMA), and the like], and dynamic viscoelasticity measurement.

A linear expansion coefficient (al) at a temperature not higher than the glass-transition temperature of the cured product of the present disclosure is not particularly limited, but is preferably from 40 to 100 ppm/° C. and more preferably from 40 to 90 ppm/° C. A linear expansion coefficient (α2) at a temperature equal to or higher than the glass-transition temperature of the cured product of the present disclosure is not particularly limited, but is preferably from 90 to 150 ppm/° C. and more preferably from 90 to 130 ppm/° C. The linear expansion coefficients α1 and α2 of the cured product may be measured by the TMA, for example.

The storage modulus of the cured product of the present disclosure at 25° C. is not particularly limited, but is preferably 0.1 GPa or more and more preferably 1 GPa or more. The storage modulus of the cured product at 25° C. may be measured by, for example, the dynamic viscoelasticity measurement.

The bending strength of the cured product of the present disclosure at 25° C. is not particularly limited, but is preferably from 80 to 200 MPa, and more preferably from 100 to 200 MPa. The bending strain (strain at the maximum bending stress) of the cured product of the present disclosure at 25° C. is not particularly limited, but is preferably 2% or greater and more preferably 3% or greater. The bending strength and bending strain of the cured product at 25° C. can be measured in accordance with JIS K7171, for example.

Since the curable composition of the present disclosure has excellent curability and can form a cured product having excellent heat resistance, the curable composition may be preferably used as a material for forming an optical member (composition for forming an optical member). That is, the optical member described above includes a cured product obtained by curing the curable composition (composition for forming the optical member) of the present disclosure. Examples of the optical member include a member that realizes various optical functions such as light diffusion, light transmittance, and light reflection, and a member that constitutes a device or instrument which utilizes the above optical functions (these may be collectively referred to as an “optical device”). Specific examples of the optical member include: a color filter, a color filter protective film, a TFT flattening film, a substrate material, a light guide plate, a prism sheet, a polarizing plate (polarizing film), a retardation plate (retardation film), a viewing angle correction film, a polarizer protective film, various coating materials (coating agents), an adhesive material (adhesive agent), an encapsulating material (encapsulating agent), and the like in a liquid crystal display device; a mold material (mold agent) of a photosemiconductor element, an encapsulating material (encapsulating agent), a front glass protective film, a front glass alternative material, various coating agents, an adhesive material (adhesive agent), and the like in a photosemiconductor display device; an antireflection film, an optical correction film, a housing material, a front glass protective film, a front glass alternative material, various coating materials (coating agents), an adhesive material (adhesive agent), and the like in a plasma display panel; a substrate material, a light guide plate, a prism sheet, a polarizing plate, a retardation plate, a viewing angle correction film, a polarizer protective film, various coating materials (coating agents), an adhesive material (adhesive agent), and the like in a plasma address display liquid crystal display; a front glass protective film, a front glass alternative material, various coating materials (coating agents), an adhesive material (adhesive agent), and the like in an organic electroluminescence display; and various film substrates, a front glass protective film, a front glass alternative material, various coating materials (coating agents), an adhesive material (adhesive agent), and the like in a field emission display.

Examples of the optical member include: optical members used in the optical recording field [for example, CD/CD-ROM, CD-R/RW, DVD-R/DVD-RAM, MO/MD, PD (phase-change disk), Blu-Ray, and a disk substrate material for an optical card; a pickup lens; a light receiving sensor portion; a protective film; various coating materials (coating agents), and an adhesive material (adhesive agent)], optical members in the optical instrument field [for example, a lens material, a finder prism, a target prism, a finder cover, a light receiving sensor portion, various coating materials (coating agents), and an adhesive material (adhesive agent) of a still camera; an image-capture lens, a finder, various coating materials (coating agents), and an adhesive material (adhesive agent) of a video camera; a projection lens, a protective film, various coating materials (coating agents), and an adhesive material (adhesive agent) of a projection television; a lens material, various films, various coating materials (coating agents), and an adhesive material (adhesive agent) for a light sensing instrument; and a camera lens, various coating materials (coating agents), and an adhesive material (adhesive agent) in a mobile terminal such as a smartphone], optical members used in the optical component field [for example, a fiber material, a lens, a waveguide, an element, various coating materials (coating agents), and an adhesive material (adhesive agent) in and around an optical switch in an optical communication system; an optical fiber material, a ferrule, various coating materials (coating agents), and an adhesive material (adhesive agent) in and around an optical connector; a lens, a waveguide, various coating materials (coating agents), and an adhesive material (adhesive agent) in an optical passive component and optical circuit component; a substrate material, a fiber material, various coating materials (coating agents), and an adhesive material (adhesive agent) in and around an optical-electrical integrated circuit (OEIC)]; optical members used in the optical fiber field [for example, decoration display illumination and light guides, sensors for industrial use, display and signs, optical fibers for a communication infrastructure and a domestic digital instrument connection, various coating materials (coating agents), and an adhesive material (adhesive agent)], and optical members used in the fields of optical and electronic function organic materials [for example, a material for an organic EL element and its periphery; an organic photorefractive element; a light amplification element serving as a light-light conversion device; an optical operation element; a substrate material, a fiber material, an element encapsulating material (encapsulating agent), various coating materials (coating agents), and an adhesive material (adhesive agent) in and around an organic solar battery].

In addition, examples of the optical member include: optical members used in the automobile and transport aircraft fields [for example, lamp materials such as an automobile headlamp, tail lamp and interior lamp, a lamp reflector, a lamp lens, various interior and exterior parts such as an exterior panel and an interior panel, a glass substitute, various coating materials (coating agents), and an adhesive material (adhesive agent); an exterior component, a glass substitute, various coating materials (coating agents), and an adhesive material (adhesive agent) for a railway vehicle; and an exterior component, a glass substitute, various coating materials (coating agents), and an adhesive material (adhesive agent) for an aircraft], optical members used in the building field [for example, a glass interlayer, a glass substitute, various coating materials (coating agents), and an adhesive material (adhesive agent)], and optical members used in the agricultural field (for example, a house covering film, various coating materials (coating agents), and an adhesive material (adhesive agent)].

By using the optical member described above including the cured product formed by curing the curable composition (composition for forming an optical member) of the present disclosure, it is possible to produce an optical device including the optical member. Examples of the optical device include, but are not particularly limited to, various optical devices including the above optical members (for example, a liquid crystal display device, a photosemiconductor display device, a plasma display panel, an organic electroluminescence display, a field emission display, and a mobile terminal such as a smartphone or a cellular phone).

The curable composition of the present disclosure has excellent high-speed curability (curability of rapid curing by being heated for about two to three minutes), and a cured product formed by curing the curable composition (the cured product of the present disclosure) also has excellent reflow heat resistance (heat resistance that hardly causes discoloration even when subjected to heat treatment in a reflow process), and thus the curable composition of the present disclosure may be particularly preferably used as a material for forming a wafer-level lens (a curable composition for a wafer-level lens). That is, the wafer-level lens of the present disclosure contains the cured product of the curable composition (curable composition for a wafer-level lens) of the present disclosure. The curing of the curable composition for a wafer-level lens of the present disclosure may proceed, for example, by a method described in the following section of “Method for Producing Wafer-Level Lens”.

### Method for Producing Wafer-Level Lens

By curing and molding the curable composition of the present disclosure, a wafer-level lens (referred to as a “wafer-level lens of the present disclosure” in some cases) is produced. Specifically, the wafer-level lens of the present disclosure is produced by a method in which the curable composition of the present disclosure is subjected to a casting molding method or an injection molding method (which may be referred to as a “method for producing a wafer-level lens of the present disclosure”).

The material of a mold used for molding the wafer-level lens (a wafer-level lens mold) is not particularly limited, and may be, for example, any of metal, glass, and plastic.

### Casting Molding Method

Examples of the casting molding method include a method including all of 1a to 3a below.
1a: preparing a wafer-level lens mold including one or more lens molds,
2a: bringing the curable composition of the present disclosure into contact with the wafer-level lens mold, which is performed after 1a,
3a: curing the curable composition of the present disclosure by heating and/or light irradiation, which is performed after 2a.

The curing of the curable composition of the present disclosure is performed by heat treatment and/or light irradiation (3a). When heat treatment is performed, the temperature thereof can be adjusted as appropriate depending on the components to be subjected to the reaction, the type of the catalyst and the like, and is not particularly limited but is preferably from 100 to 200° C. and more preferably from about 120 to about 160° C. When light irradiation is performed, as the light source thereof, for example, a mercury lamp, a xenon lamp, a carbon arc lamp, a metal halide lamp, sunlight, an electron beam source, or a laser light source may be used. After the light irradiation, heat treatment, for example, may be performed at a temperature of about 50 to 180° C. to allow the curing reaction to proceed further.

The casting molding method may further include the following 4a to be performed after 3a.
4a: performing annealing treatment on the cured curable composition of the present disclosure (cured product of the present disclosure).

The annealing treatment is performed, although not particularly limited, by heating at a temperature of 100 to 200° C. for approximately 30 minutes to 1 hour, for example. The annealing treatment may be performed after removing the wafer-level lens mold, or may be performed without removing the wafer-level lens mold.

When the casting molding method is carried out particularly by a simultaneous molding method described below, a sheet-shaped cured product (wafer-level lens sheet) formed in a state in which one or more wafer-level lenses are connected in series may be usually produced by 3a or 4a discussed above. In a case where the wafer-level lens sheet includes a plurality of wafer-level lenses, these wafer-level lenses may be regularly arranged (aligned) or may be randomly arranged. The wafer-level lens of the present disclosure is produced by cutting the wafer-level lens sheet and removing unnecessary portions.

That is, when the casting molding method is carried out particularly by the simultaneous molding method described below, the casting molding method may further include the following 5a to be performed after 3a or 4a.
5a: cutting the cured curable composition of the present disclosure (the cured product of the present disclosure, which is usually a wafer-level lens sheet).

The cutting of the cured curable composition of the present disclosure (the cured product of the present disclosure) may be performed by a known or commonly used processing scheme or the like.

More specifically, the casting molding method includes the simultaneous molding method including 1-1 to 1-3 below, and an individual piece molding method including 2-1 and 2-2 below.

### Simultaneous Molding Method

1-1: pouring the curable composition of the present disclosure into a wafer-level lens mold having a shape in which a plurality of lens molds are aligned in a certain direction, and curing the poured composition by heating and/or light irradiation,
1-2: after 1-1, removing the wafer-level lens mold and performing annealing treatment to produce a cured product (wafer-level lens sheet) having a shape in which a plurality of wafer-level lenses are bonded,
1-3: after 1-2, cutting the produced cured product to produce a wafer-level lens.

### Individual Piece Molding Method

2-1: pouring the curable composition of the present disclosure into a wafer-level lens mold having one lens mold, and curing the poured composition by heating and/or light irradiation
2-2: after 2-1, removing the wafer-level lens mold and performing annealing treatment to produce a wafer-level lens.

### Injection Molding Method

Examples of the injection molding method include a method including all of 1b to 3b below.
1b: preparing a wafer-level lens mold including one or more lens molds,
2b: after 1b, injecting the curable composition of the present disclosure into the wafer-level lens mold,
3b: after 2b, curing the curable composition of the present disclosure by heating and/or light irradiation.

The curing of the curable composition of the present disclosure in the injection molding method is performed by heat treatment and/or light irradiation, and more specifically, may be performed in a similar manner to that of the curing in the casting molding method described above.

The injection molding method may further include the following 4b after the 3b.
4b: performing annealing treatment on the cured curable composition of the present disclosure (cured product of the present disclosure).

The annealing treatment is performed, although not particularly limited, by heating at a temperature of 100 to 200° C. for approximately 30 minutes to 60 minutes, for example. The annealing treatment may be performed after removing the wafer-level lens mold, or may be performed without removing the wafer-level lens mold.

The injection molding method may further include removing burrs or the like after 3b or 4b.

In the simultaneous molding method in the casting molding method, it is preferable for the curable composition of the present disclosure to have excellent fluidity with low viscosity in the view of fillability into the wafer-level lens mold. The viscosity at 25° C. of the curable composition of the present disclosure used in the simultaneous molding method is not particularly limited, but is preferably 3600 mPa·s or less, more preferably 2500 mPa·s or less, further more preferably 2000 mPa·s or less, and particularly preferably 1500 mPa·s or less. Adjusting the viscosity of the curable composition of the present disclosure to the range described above may increase the fluidity and make the air bubbles unlikely to remain. Thus, filling of the wafer-level lens mold with the curable composition can be carried out while an increase in injection pressure is suppressed. That is, coatability and fillability may be improved, and workability may be improved throughout the molding operation of the curable composition of the present disclosure.

The cured product of the curable composition of the present disclosure (cured product of the present disclosure) has excellent heat resistance even in a high-temperature environment of about 100 to 200° C. and has an excellent shape retention property. This makes it possible to efficiently produce a wafer-level lens having excellent lens center position accuracy even when annealing treatment is performed after the wafer-level lens is removed from the wafer-level lens mold. As for the lens center position accuracy, the deviation of the lens center position is, for example, preferably about ±2 μm or less, and more preferably about ±1 μm or less. When a plurality of wafer-level lenses produced by a method for producing a wafer-level lens of the present disclosure are laminated and joined, a cemented lens (laminated wafer-level lens) having a significantly large number of pixels and exhibiting excellent optical characteristics can be formed.

Since the cured product of the curable composition of the present disclosure (cured product of the present disclosure) has an excellent shape retention property even in a high-temperature environment as described above, the lens pitch does not shift even when annealing treatment is performed. Then, in 1-3 of the simultaneous molding method, a plurality of wafer-level lenses can be separated without being damaged by stacking a plurality of the cured products and determining the positions of cutting lines with reference to the uppermost cured product, and thus it is possible to reduce cost and improve work efficiency.

The wafer-level lens of the present disclosure may also be used as a constituent member of a laminate of a plurality of wafer-level lenses (referred to as a “laminated wafer-level lens” in some cases). That is, the laminated wafer-level lens of the present disclosure includes at least the wafer-level lens of the present disclosure as a wafer-level lens constituting the laminated wafer-level lens. All of the wafer-level lenses constituting the laminated wafer-level lens of the present disclosure may be the wafer-level lenses of the present disclosure; alternatively, they may be the wafer-level lenses of the present disclosure and other wafer-level lenses. The number of wafer-level lenses constituting the laminated wafer-level lens of the present disclosure is not particularly limited, and is, for example, two to five (particularly two to three).

The laminated wafer-level lens of the present disclosure may be produced by a known or commonly used method, and is not particularly limited. For example, it may be produced by laminating a plurality of wafer-level lenses including the wafer-level lens of the present disclosure, or may also be produced by laminating a plurality of wafer-level lens sheets including the wafer-level lens sheet obtained by the simultaneous molding method described above to produce a wafer-level lens sheet laminate (a laminate of the wafer-level lens sheets), and then cutting the wafer-level lens sheets. In the laminated wafer-level lens (or the wafer-level lens sheet laminate) of the present disclosure, the wafer-level lenses (or the wafer-level lens sheets) may or may not be bonded to each other by a known or commonly used bonding scheme.

To be more specific, the laminated wafer-level lens of the present disclosure may be produced by, for example, a method including all of 1c to 5c below.
1c: preparing a wafer-level lens mold including one or more lens molds,
2c: after 1c, bringing the curable composition of the present disclosure into contact with the wafer-level lens mold,
3c: after 2c, curing the curable composition of the present disclosure by heating and/or light irradiation to produce a wafer-level lens sheet,
4c: after 3c, laminating a plurality of wafer-level lens sheets including the wafer-level lens sheet described above to produce a wafer-level lens sheet laminate,
5c: after 4c, cutting the wafer-level lens sheet laminate.

The method for producing the laminated wafer-level lens may further include 6c between 3c and 4c.
6c: performing annealing treatment on the wafer-level lens sheet.

The wafer-level lens or laminated wafer-level lens of the present disclosure is excellent in heat resistance and optical characteristics, can exhibit an excellent shape retention property even when exposed to a high-temperature environment, and can maintain the excellent optical characteristics. Thus, it may be preferably used as, for example, an imaging lens of a camera (a vehicle-mounted camera, a digital camera, a camera for a PC, a camera for a cellular phone, a monitoring camera, or the like) in various optical devices, a spectacle lens, a light beam condensing lens, a light diffusing lens, or the like. The optical device described above equipped with the wafer-level lens or the laminated wafer-level lens of the present disclosure has high quality.

In addition, when the wafer-level lens or the laminated wafer-level lens of the present disclosure is mounted on a circuit board, it can be soldered by reflow soldering. Because of this, the camera module equipped with the wafer-level lens of the present disclosure may be directly and very efficiently mounted on a printed circuit board (PCB) of a cellular phone or the like in the same solder reflow process as the surface mounting of other electronic components, and consequently, an optical device may be produced very efficiently.

Each aspect disclosed in the present specification can be combined with any other feature disclosed herein.

Note that each of the configurations, combinations thereof, and the like in each of the embodiments are an example, and various additions, omissions, substitutions, and other changes may be made as appropriate without departing from the spirit of the present disclosure. The present disclosure is not limited by the embodiment and is

limited only by the claims.

### Examples

Hereinafter, the present disclosure will be described more specifically with reference to examples, but the present disclosure is not limited by these examples.

### Production Example 1

### Production of Alicyclic Epoxy Compound

A dehydration catalyst was prepared by mixing 70 g (0.68 mol) of 95 wt. % sulfuric acid and 55 g (0.36 mol) of 1,8-diazabicyclo[5.4.0]undecene-7 (DBU) under stirring.

A 3-liter flask including a stirrer, a thermometer and a discharge pipe, and equipped with a warmed distillation pipe was filled with 1000 g (5.05 mol) of hydrogenated biphenol (4,4′-dihydroxybicyclohexyl), 125 g of the dehydration catalyst (0.68 mol as sulfuric acid) prepared as above and 1500 g of pseudocumene, and then the flask was heated. Formation of water was observed about when the internal temperature exceeded 115° C. The temperature was further continuously raised to the boiling point of pseudocumene (internal temperature from 162 to 170° C.) to perform a dehydration reaction at normal pressure. The by-produced water was distilled off and discharged out of the system through the discharge pipe. Here, the dehydration catalyst was liquid under the reaction conditions and was finely dispersed in the reaction liquid. After 3 hours, most of the theoretical amount of water (180 g) was distilled off, and thus the reaction was completed. The liquid after reaction was distilled, after the pseudocumene was distilled off, by using a 10-stage Oldershaw-type distillation column, at an internal pressure of 10 Torr (1.33 kPa) and an internal temperature of 137 to 140° C. to obtain 731 g of bicyclohexyl-3,3′-diene. Then, 243 g of the obtained bicyclohexyl-3,3′-diene and 730 g of ethyl acetate were charged in a reactor, and 274 g of an ethylacetate solution (moisture percentage of 0.41 wt. %) of 30 wt. % peracetic acid was added dropwise in about three hours while supplying nitrogen into the gas phase portion and controlling the temperature in the reaction system to 37.5° C. After completion of the dropwise addition of the peracetic acid solution, the mixture was aged at 40° C. for one hour, and then the reaction was completed. Furthermore, the crude liquid at the end of the reaction was washed with water at 30° C., and low-boiling point compounds were removed at 70° C./20 mmHg to obtain 270 g of an alicyclic epoxy compound. The oxirane oxygen concentration of the obtained alicyclic epoxy compound was 15.0 wt. %. In the ¹H-NMR measurement, the peak attributed to the internal double bond at or near δ4.5 to 5 ppm disappeared, the generation of the proton peak attributed to an epoxy group at or near δ3.1 ppm was confirmed, and the above-mentioned alicyclic epoxy compound was confirmed to be 3,4,3′,4′-diepoxybicyclohexyl.

### Production Example 2

### Production of Alicyclic Epoxy Compound

Tetrahydrobenzyl alcohol (400 g, 3.57 mol), triethylamine (379 g, 3.74 mol), and toluene (927 mL) were added to a 5 L reactor, nitrogen purge was performed, and thereafter the reactor was cooled to 5° C.

Then, a toluene (461 mL) solution of methanesulfonyl chloride (429 g, 3.74 mol) was added dropwise thereto in a range from 5 to 10° C., accompanied by aging for 30 minutes. Thereafter, ion-exchange water was added into the reaction system to stop the reaction, and an extracted organic layer was washed once with a sodium hydrogen carbonate aqueous solution, once with a 1M hydrochloric acid aqueous solution, and once with ion-exchange water. The obtained organic layer was concentrated to obtain tetrahydrobenzyl methanesulfonate (yield: 98%).

Sodium hydroxide (granular) (499 g, 12.48 mol) and toluene (727 mL) were added to a 5 L reactor, and nitrogen purge was performed. Then, a toluene (484 mL) solution of tetrahydrobenzyl alcohol (420 g, 3.74 mol) was added, and aging was performed at 70° C. for 1.5 hours. Subsequently, the above-obtained tetrahydrobenzyl methanesulfonate (419 g, 2.20 mol) was added, the mixture was aged under reflux for three hours and thereafter cooled to room temperature, and the reaction was stopped by adding water (1248 g), followed by liquid separation. The separated organic layer was concentrated and distilled under reduced pressure to obtain ditetrahydrobenzyl ether as a colorless transparent liquid (conversion rate: 99%, selectivity: 98%, yield: 85%).

The obtained ditetrahydrobenzyl ether (200 g, 0.97 mol), 20% SP-D (acetic acid solution) (0.39 g), and ethyl acetate (669 mL) were added to the reactor, followed by heating to 40° C. Subsequently, 29.1% peracetic acid (608 g, corresponding to 2.4 mol relative to 1 mol of ditetrahydrobenzyl ether) was added dropwise in five hours, and the mixture was aged for three hours. Thereafter, the organic layer was washed three times with an aqueous alkali solution and twice with ion-exchange water, and distillation was performed under reduced pressure to obtain bis (3, 4-epoxycyclohexylmethyl) ether as a colorless transparent liquid (yield: 77%).

### Production Example 3

### Production of Alicyclic Epoxy Compound

6 kg (25.0 mol) of hydrogenated bisphenol-A and 490 g (3.6 mol) of potassium hydrogensulfate were added to a 10-liter four neck flask equipped with a stirrer, a distillation column and a thermometer, and the mixture was heated to 140° C. to melt the hydrogenation bisphenol-A. After melting, the mixture was further heated to 180° C., and when stirring was started, the reaction was gradually started, and 505 ml (28 mol) of water corresponding to 56% of the theoretical amount was distilled at atmospheric pressure in four hours.

Thereafter, the pressure in the reaction system was reduced to 10 Torr at the same temperature, and water and 2,2-bis (3′-cyclohexenyl) propane were distilled from the top of the distillation column in five hours. The distilled water and 2,2-bis(3′-cyclohexenyl) propane were separated into two layers using a decanter, and 2,2-bis (3′-cyclohexenyl) propane in the upper layer was taken out.

Thereafter, the reaction was ended at a point of time when the distillation of water and 2,2-bis (3′-cyclohexenyl) propane ceased. The yield of the distillation crude liquid of 2,2-bis (3′-cyclohexenyl) propane was 4880 g.

The reaction was carried out at 45° C. by supplying compressed air into a 300-ml stainless steel reactor equipped with an air supply port, a gas dispersing perforated plate and a cooling jacket while charging a solution of 10% acetaldehyde-ethyl acetate containing cobalt acetate into the reactor at a rate of 114 kg/hour. The reaction solution contained 10.2% of peracetic acid, 2.1% of acetaldehyde monoperacetate, and 2.1% of acetic acid. This solution was charged into a distillation column together with sodium polyphosphate, and concentrated to obtain a peracetic acid solution. The obtained peracetic acid solution was such that the peracetic acid concentration was 29.2% and water was 0.31% in content.

100 g of the above-obtained 2,2-bis(3′,4′-cyclohexenyl) propane and 300 g of ethyl acetate were charged in a 1-liter jacketed flask, and while supplying nitrogen to the gas phase portion, 307.2 g of an ethyl acetate solution of the substantially anhydrous peracetic acid obtained above (peracetic acid concentration: 29.2%, water content: 0.31%) was added dropwise in about two hours in such a manner as to control the temperature in the reaction system to be 30° C. After completion of the dropwise addition of peracetic acid, the mixture was aged at 30° C. for three hours, and then the reaction was completed. Further, the solution after the reaction was washed with water at 30° C., subjected to low boiling point component removal at 70° C./20 Torr, and then distilled by a WFE type thin film vaporizer under conditions of a heating temperature of 180° C. and a pressure of 4 Torr, thereby obtaining 71.2 g of 2,2-bis(3,4-epoxycyclohexyl) propane.

### Examples 1 to 10 and Comparative Examples 1 to 8

The components depicted in Table 1 given below were blended in accordance with the blending composition (numerical values are in parts by weight) depicted in Table 1, and were stirred and mixed at room temperature with a planetary centrifugal mixer to obtain a uniform and transparent curable composition (cationically curable composition).

Subsequently, the curable composition obtained above was cured by the following heat treatment method or UV irradiation method to obtain a cured product. Table 1 illustrates which curing method was used for curing. In the preparation of the cured product described below, a flat mold having no lens shape was used.

### Heat Treatment Method

By using an imprint molding machine (trade name “NANOIMPRINTER NM-0501”, available from Meisyo Kiko Co., Ltd.), the curable composition was cured and molded with a thickness of 0.5 mm in accordance with the following molding profile, cooled to 80° C., and then demolded. Further, the demolded composition was annealed by heating in an oven preheated to 200° C. for 30 minutes to obtain cured products (5 pieces each).

Molding profile: the curable composition was coated to a mold at 25° C., then the mold was pressed by adjusting the press shaft position until a predetermined thickness was reached, the temperature was raised to 170° C. at a rate of 20° C./min, and then the temperature of 170° C. was maintained for 10 minutes.

### UV Irradiation Method

By using an imprint molding machine (trade name “NANOIMPRINTER NM-0501”, available from Meisyo Kiko Co., Ltd.), the curable composition was cured and molded with a thickness of 0.5 mm in accordance with the following molding profile, subsequently demolded, and annealed by heating in an oven preheated to 200° C. for minutes to obtain cured products (5 pieces each).

Molding profile: the curable composition was coated to a mold at 25° C., then the mold was pressed by adjusting the press shaft position until a predetermined thickness was reached, and irradiation of UV-LED (λ=365 nm) was made (irradiation intensity=100 mW/cm², 30 seconds, cumulative irradiation amount=3000 mJ/cm²).

TABLE 1

| | | Example | Comparative | Comparative | Comparative | Example | Comparative | Comparative | Comparative |
|---|---|---|---|---|---|---|---|---|---|
| | | 1 | Example 1 | Example 2 | Example 3 | 2 | Example 4 | Example 5 | Example 6 |
| Curable | C-1 | 30 | 30 | 30 | 30 | 30 | 30 | 30 | 30 |
| compound | C-2 | — | — | — | — | — | — | — | — |
| | A-1 | 40 | 40 | 40 | 40 | 40 | 40 | 40 | 40 |
| | A-2 | — | — | — | — | — | — | — | — |
| | A-3 | — | — | — | — | — | — | — | — |
| | E-1 | — | — | — | — | — | — | — | — |
| | D-1 | 30 | 30 | 30 | 30 | 30 | 30 | 30 | 30 |
| | G-1 | — | — | — | — | — | — | — | — |
| | F-1 | — | — | — | — | — | — | — | — |
| Thermal cationic | B-1 | 0.1 | — | — | — | — | — | — | — |
| polymerization | B-2 | — | 0.2 | — | — | — | — | — | — |
| initiator | B-3 | — | — | 0.1 | — | — | — | — | — |
| | B-4 | — | — | — | 0.1 | — | — | — | — |
| Photocationic | B-5 | — | — | — | — | 0.25 | — | — | — |
| polymerization | B-6 | — | — | — | — | — | 0.5 | — | — |
| initiator | B-7 | — | — | — | — | — | — | 0.5 | — |
| | B-8 | — | — | — | — | — | — | — | 0.25 |
| | B-9 | — | — | — | — | — | — | — | — |
| Antioxidant | IRG1010 | 0.5 | 0.5 | 0.5 | 0.5 | 0.5 | 0.5 | 0.5 | 0.5 |
| | JIP-10 | 0.5 | 0.5 | 0.5 | 0.5 | 0.5 | 0.5 | 0.5 | 0.5 |

| | | | | | | | | |
|---|---|---|---|---|---|---|---|---|
| Curing method | Heating | Heating | Heating | Heating | UV | UV | UV | UV |
| | | | | | irradiation | irradiation | irradiation | irradiation |

| | | Comparative | Example | Example | Exam- | Comparative | Exam- | Example | Exam- | | Example |
|---|---|---|---|---|---|---|---|---|---|---|---|
| | | Example 7 | 3 | 4 | ple 5 | Example 8 | ple 6 | 7 | ple 8 | Example 9 | 10 |
| Curable | C-1 | 30 | 30 | 30 | — | 50 | 30 | 40 | — | 30 | 30 |
| compound | C-2 | — | — | — | — | — | — | — | 30 | — | |
| | A-1 | 40 | — | — | 40 | — | 40 | 60 | 40 | 40 | 40 |
| | A-2 | — | 40 | — | — | — | — | — | — | — | — |
| | A-3 | — | — | 40 | — | — | — | — | — | — | — |
| | E-1 | — | — | — | — | — | 15 | — | — | — | — |
| | D-1 | 30 | 30 | 30 | 30 | 50 | 15 | — | 30 | 15 | — |
| | G-1 | — | — | — | 30 | — | — | — | — | — | — |
| | F-1 | — | — | — | — | — | — | — | — | 15 | 30 |
| Thermal cationic | B-1 | — | 0.1 | 0.1 | 0.1 | 0.1 | 0.1 | 0.1 | 0.1 | — | — |
| polymerization | B-2 | — | — | — | — | — | — | — | — | — | — |
| initiator | B-3 | — | — | — | — | — | — | — | — | — | — |
| | B-4 | — | — | — | — | — | — | — | — | — | — |
| Photocationic | B-5 | — | — | — | — | — | — | — | — | 0.25 | 0.25 |
| polymerization | B-6 | — | — | — | — | — | — | — | — | — | — |
| initiator | B-7 | — | — | — | — | — | — | — | — | — | — |
| | B-8 | — | — | — | — | — | — | — | — | — | — |
| | B-9 | 0.25 | — | — | — | — | — | — | — | — | — |
| Antioxidant | IRG1010 | 0.5 | 0.5 | 0.5 | 0.5 | 0.5 | 0.5 | 0.5 | 0.5 | 0.5 | 0.5 |
| | JIP-10 | 0.5 | 0.5 | 0.5 | 0.5 | 0.5 | 0.5 | 0.5 | 0.5 | 0.5 | 0.5 |

| | | | | | | | | | | |
|---|---|---|---|---|---|---|---|---|---|---|
| Curing method | UV | Heating | Heating | Heating | Heating | Heating | Heating | Heating | UV | UV |
| | irradiation | | | | | | | | irradiation | irradiation |

Abbreviations in Table 1 will be described below.

### Curable Compound

C-1: cyclic siloxane having four alicyclic epoxy groups in a molecule (available from Shin-Etsu Chemical Co., Ltd., trade name “KR-470”)
C-2: cyclic siloxane having two glycidyl groups in a molecule (available from Shin-Etsu Chemical Co., Ltd., trade name “X-40-2728”)
A-1: compound (3,4,3′,4′-diepoxybicyclohexyl) obtained in Production Example 1
A-2: compound (bis(3, 4-epoxycyclohexylmethyl) ether) obtained in Production Example 2
A-3: compound (2,2-bis(3,4-epoxycyclohexyl)propane) obtained in Production Example 3
E-1: 3,4-epoxycyclohexylmethyl(3,4-epoxy)cyclohexanecarboxylate (available from Daicel Corporation, trade name “CELLOXIDE 2021P”)
D-1: hydrogenated bisphenol type diglycidyl compound (available from Mitsubishi Chemical Corporation, trade name “YX8000”)
G-1: bisphenol type diglycidyl compound (available from Mitsubishi Chemical Corporation, trade name “jER827”)
F-1: 3-ethyl-3-{[(3-ethyloxetane-3-yl)methoxy]methyl }oxetane (available from Toa Gosei Co., Ltd., trade name “ARON OXETANE OXT221”)

### Thermal Cationic Polymerization Initiator

B-1: aromatic sulfonium salt containing gallium as an anion moiety (prepared according to JP 2017-048325 A)
B-2: aromatic sulfonium salt containing antimony as an anion moiety (available from Sanshin Chemical Industry Co., Ltd., trade name “SAN-AID SI-100L”)
B-3: aromatic sulfonium salt containing phosphorus as an anion moiety (available from Sanshin Chemical Industry Co., Ltd., trade name “SAN-AID SI-110”)
B-4: aromatic sulfonium salt containing boron as an anion moiety (available from Sanshin Chemical Industry Co., Ltd., trade name “SAN-AID SI-B3”)

### Photocationic Polymerization Initiator

B-5: aromatic sulfonium salt containing gallium as an anion moiety (prepared according to JP 2017-048325 A)
B-6: aromatic sulfonium salt containing antimony as an anion moiety (available from San-Apro Ltd., trade name “CPI-101A”)
B-7: aromatic sulfonium salt containing phosphorus as an anion moiety (available from San-Apro Ltd., trade name “CPI-100P”)
B-8: aromatic sulfonium salt containing phosphorus as an anion moiety (available from San-Apro Ltd., trade name “CPI-210B”)
B-9: aromatic sulfonium salt containing boron as an anion moiety (available from San-Apro Ltd., trade name “CPI-310B”)

### Antioxidant

IRG1010: pentaerythritol tetrakis[3-(3,5-di-t-butyl-4-hydroxyphenol)propionate] (available from BASF, trade name “IRGANOX1010”)
HP10: 2,2′-methylenebis(4,6-di-t-butylphenyl)octylphosphite (available from ADEKA Chemical Supply Corporation, trade name “HP-10”)

The curable compositions obtained in Examples and Comparative Examples were evaluated as follows.

### Coatability and Defoaming Property

In the above-described “heat treatment method” and “UV irradiation method”, coatability and defoaming property of the curable composition to the mold by a volumetric dispenser were evaluated based on the following criteria.
Good: coating was possible, no air bubbles were mixed in after coating
Poor: coating was impossible, air bubbles were mixed in after coating

### Curability

In the above-described “heat treatment method” and “UV irradiation method”, curability of the curable composition was evaluated based on the following criteria.
Good: cured sufficiently (demolding is possible)
Poor: semi-cured to uncured (demolding is impossible)

The cured products obtained in Examples and Comparative Examples were evaluated as follows.

The following evaluations were not carried out in Comparative Examples 2, 5 and 8, in which demolding was impossible because the curability was in a range from being semi-cured to uncured in the above curability evaluation.

### Transmittance After Annealing

The transmittance of each of the cured products after annealing obtained in Examples and Comparative Examples was measured using a spectrophotometer (available from Hitachi High-Tech Corporation, trade name “U-3900”) in a wavelength range from 190 nm to 800 nm. From the obtained results, light transmittance at 400 nm, 500 nm, 550 nm, and 600 nm was obtained as external transmittance (%).

In addition, the internal transmittance was calculated by the following equation.

Internal transmittance at 400 nm=light transmittance at 400 nm/(1−r)²

r={(n−1)/(n+1)}²

Note that n is a refractive index at 400 nm, and the value of the refractive index at 400 nm measured according to a refractive index measurement method described below was used. The internal transmittance at 450 nm, 500 nm, 550 nm, and 600 nm was also calculated according to the above scheme.

### Transmittance After Reflow

The cured products after annealing obtained in Examples and Comparative Examples were subjected to the following reflow conditions, and then the external transmittance and the internal transmittance at 400 nm, 450 nm, 500 nm, 550 nm, and 600 nm were calculated in accordance with the above “Transmittance after Annealing”.

### Reflow Conditions

In accordance with IPC/JEDEC J-STD-020, the cured products were heated to reach 260° C. based on a profile of Table 2 given below, maintained at 260° C. for 30 seconds after reaching 260° C., and then cooled to 25° C. at a rate of 2° C./min or more. The reflow was performed three times.

TABLE 2

| | Time | | | | | |
|---|---|---|---|---|---|---|
| | 0 sec | 40 sec | 70 sec | 140 sec | 155 sec | 200 sec |
| Temperature | 50° C. | 150° C. | 180° C. | 200° C. | 220° C. | 260° C. |

### Refractive Index

The refractive index of each of the annealed cured products obtained in Examples and Comparative Examples was measured at 25° C. using a refractometer (available from Metricon Corporation, trade name “Model 2010”) by a method in accordance with JIS K7142 for light having wavelengths of 407 nm, 633 nm, 826 nm and 1309 nm, and the refractive index for light having a wavelength of 589 nm was calculated by the following Cauchy's dispersion equation.

$$n ( λ ) = A + \frac{B}{{λ}^{2}} + \frac{C}{{λ}^{4}} \qquad [ Math . 1 ]$$

### Appearance

The cured products obtained in Examples and Comparative Examples were visually evaluated for appearance before annealing, after annealing, and after reflow.

The evaluation results are collectively depicted in Table 3.

TABLE 3

| | | | | Com- | | | | Com- | | |
|---|---|---|---|---|---|---|---|---|---|---|
| | | | Comparative | parative | Comparative | | Comparative | parative | Comparative | Comparative |
| | | Example 1 | Example 1 | Example 2 | Example 3 | Example 2 | Example 4 | Example 5 | Example 6 | Example 7 |
| Coatability, defoaming | | Good | Good | Good | Good | Good | Good | Good | Good | Good |
| property | | | | | | | | | | |
| Curability | | Good | Good | Poor | Good | Good | Good | Poor | Good | Good |
| Appearance before | | Transparent | Transparent | — | Transparent | Transparent | Transparent | — | Transparent | Light yellow |
| annealing | | | | | | | | | | |
| Appearance after | | Transparent | Transparent | — | Light brown | Transparent | Transparent | — | Light yellow | Reddish |
| annealing | | | | | | | | | | brown |
| External | 400 nm | 88.3 | 90.5 | — | 76.7 | 84.6 | 87.9 | — | 33.9 | 13.7 |
| transmittance | 450 nm | 91.4 | 91.9 | — | 85.3 | 89.5 | 90.4 | — | 68.8 | 36.3 |
| [%] after | 500 nm | 92.2 | 92.4 | — | 87.5 | 90.8 | 91.3 | — | 82.9 | 46.7 |
| annealing | 550 nm | 92.6 | 92.7 | — | 89.2 | 91.4 | 91.8 | — | 88.4 | 55.4 |
| | 600 nm | 92.8 | 92.8 | — | 90.6 | 92.0 | 92.0 | — | 90.6 | 65.8 |
| Internal | 400 nm | 96.4 | 99.0 | — | 83.7 | 92.4 | 96.2 | — | 37.1 | 15.0 |
| transmittance | 450 nm | 99.6 | 100.0 | — | 93.0 | 97.6 | 98.7 | — | 75.0 | 39.6 |
| [%] after | 500 nm | 100.0 | 100.0 | — | 95.2 | 98.9 | 99.6 | — | 90.3 | 51.0 |
| annealing | 550 nm | 100.0 | 100.0 | — | 97.0 | 99.5 | 100.0 | — | 96.2 | 60.3 |
| | 600 nm | 100.0 | 100.0 | — | 98.5 | 100.0 | 100.0 | — | 98.5 | 71.6 |
| Appearance after reflow | | Transparent | Transparent | — | Light brown | Transparent | Transparent | — | Light yellow | Reddish |
| | | | | | | | | | | brown |
| External | 400 nm | 87.4 | 89.9 | — | 74.7 | 83.9 | 87.9 | — | 29.7 | 13.7 |
| transmittance | 450 nm | 90.9 | 91.4 | — | 83.5 | 89.2 | 90.4 | — | 66.0 | 33.7 |
| [%] after reflow | 500 nm | 91.8 | 92.0 | — | 86.0 | 90.6 | 91.3 | — | 81.4 | 43.6 |
| | 550 nm | 92.2 | 92.3 | — | 87.8 | 91.1 | 91.7 | — | 87.1 | 52.1 |
| | 600 nm | 92.3 | 92.4 | — | 89.5 | 91.3 | 91.8 | — | 89.4 | 63.5 |
| Internal | 400 nm | 95.4 | 98.3 | — | 81.6 | 91.7 | 96.1 | — | 32.4 | 15.0 |
| transmittance | 450 nm | 99.1 | 99.8 | — | 91.0 | 97.3 | 98.6 | — | 71.9 | 36.7 |
| [%] after reflow | 500 nm | 100.0 | 100.0 | — | 93.6 | 98.7 | 99.6 | — | 88.7 | 47.5 |
| | 550 nm | 100.0 | 100.0 | — | 95.5 | 99.2 | 99.9 | — | 94.8 | 56.8 |
| | 600 nm | 100.0 | 100.0 | — | 97.2 | 99.3 | 99.9 | — | 97.2 | 69.1 |

| | | | | | | | | | |
|---|---|---|---|---|---|---|---|---|---|
| Refractive index | 1.5071 | 1.5117 | — | 1.5062 | 1.5099 | 1.5124 | — | 1.5090 | 1.5125 |

| | | | | | Com- | | | | | |
|---|---|---|---|---|---|---|---|---|---|---|
| | | | | | parative | | | | | |
| | | | | | Exam- | | | | | |
| | | Example 3 | Example 4 | Example 5 | ple 8 | Example 6 | Example 7 | Example 8 | Example 9 | Example 10 |
| Coatability, defoaming | | Good | Good | Good | Good | Good | Good | Good | Good | Good |
| property | | | | | | | | | | |
| Curability | | Good | Good | Good | Poor | Good | Good | Good | Good | Good |
| Appearance before | | Transparent | Transparent | Transparent | — | Transparent | Transparent | Transparent | Transparent | Transparent |
| annealing | | | | | | | | | | |
| Appearance after | | Transparent | Transparent | Transparent | — | Transparent | Transparent | Transparent | Transparent | Transparent |
| annealing | | | | | | | | | | |
| External | 400 nm | 87.3 | 88.6 | 87.8 | — | 86.9 | 86.9 | 88.7 | 85.7 | 86.9 |
| transmittance | 450 nm | 89.6 | 91.2 | 90.7 | — | 90.1 | 91.2 | 91.3 | 90.9 | 91.3 |
| [%] after | 500 nm | 90.5 | 91.9 | 91.5 | — | 91.0 | 92.1 | 92.1 | 91.8 | 92.1 |
| annealing | 550 nm | 91.0 | 92.4 | 91.8 | — | 91.4 | 92.4 | 92.3 | 92.1 | 92.4 |
| | 600 nm | 91.4 | 92.6 | 92.0 | — | 91.5 | 92.6 | 92.5 | 92.4 | 92.6 |
| Internal | 400 nm | 95.2 | 96.7 | 96.8 | — | 95.3 | 94.8 | 96.8 | 93.6 | 94.8 |
| transmittance | 450 nm | 97.5 | 99.3 | 99.8 | — | 98.7 | 99.3 | 99.4 | 99.0 | 99.4 |
| [%] after | 500 nm | 98.4 | 100.0 | 100.0 | — | 99.6 | 100.0 | 100.0 | 100.0 | 100.0 |
| annealing | 550 nm | 98.9 | 100.0 | 100.0 | — | 99.8 | 100.0 | 100.0 | 100.0 | 100.0 |
| | 600 nm | 99.3 | 100.0 | 100.0 | — | 99.9 | 100.0 | 100.0 | 100.0 | 100.0 |
| Appearance after reflow | | Transparent | Transparent | Transparent | — | Transparent | Transparent | Transparent | Transparent | Transparent |
| External | 400 nm | 87.4 | 88.0 | 87.2 | — | 86.9 | 85.6 | 87.8 | 85.1 | 85.8 |
| transmittance | 450 nm | 89.6 | 90.7 | 90.4 | — | 89.8 | 90.9 | 91.1 | 90.7 | 91.1 |
| [%] after reflow | 500 nm | 90.5 | 91.6 | 91.3 | — | 90.6 | 92.1 | 92.1 | 91.9 | 92.2 |
| | 550 nm | 90.8 | 91.9 | 91.7 | — | 90.9 | 92.6 | 92.5 | 92.4 | 92.7 |
| | 600 nm | 91.1 | 92.1 | 91.8 | — | 91.1 | 93.0 | 92.7 | 92.7 | 93.1 |
| Internal | 400 nm | 95.3 | 96.0 | 96.1 | — | 95.4 | 93.3 | 95.8 | 92.9 | 93.5 |
| transmittance | 450 nm | 97.6 | 98.8 | 99.5 | — | 98.4 | 98.9 | 99.3 | 98.8 | 99.2 |
| [%] after reflow | 500 nm | 98.4 | 99.7 | 100.0 | — | 99.1 | 100.0 | 100.0 | 100.0 | 100.0 |
| | 550 nm | 98.7 | 100.0 | 100.0 | — | 99.3 | 100.0 | 100.0 | 100.0 | 100.0 |
| | 600 nm | 99.0 | 100.0 | 100.0 | — | 99.4 | 100.0 | 100.0 | 100.0 | 100.0 |

| | | | | | | | | | |
|---|---|---|---|---|---|---|---|---|---|
| Refractive index | 1.5045 | 1.5059 | 1.5387 | — | 1.5228 | 1.5013 | 1.5045 | 1.5053 | 1.5012 |

The curable compositions of Examples containing a cationic polymerization initiator having an anion moiety containing a gallium atom exhibited excellent curability. On the other hand, the curable compositions of Comparative Examples 2 and 5, which contained a cationic polymerization initiator having an anion moiety containing a phosphorus atom, were inferior in curability and demolding the cured product was difficult. The curable composition of Comparative Example 8, which contained a cationic polymerization initiator having an anion moiety containing a gallium atom but did not contain the component (A), was inferior in curability and demolding the cured product was difficult.

The cured products of Examples containing a cationic polymerization initiator having an anion moiety containing a gallium atom exhibited reflow heat resistance comparable to that of the cured products of Comparative Examples 1 and 4 containing a cationic polymerization initiator having an anion moiety containing an antimony atom. On the other hand, the cured products of Comparative Examples 3, 6, and 7 containing a cationic polymerization initiator having an anion moiety containing a phosphorus atom or a boron atom were inferior in heat resistance and were yellowed or browned.

From the above results, it is understood that the curable composition of the present disclosure includes the composition (A) as a compound including an alicyclic epoxy group and not including an ester bond and the component (B) as a cationic polymerization initiator having an anion moiety containing a gallium atom can form a cured product excellent in curability and also excellent in heat resistance without using antimony, which is environmentally regulated.

Hereinafter, variations of the present disclosure will be described.

### Addendum 1

A curable composition including components (A) and (B):
Component (A): a compound including an alicyclic epoxy group and including no ester bond, and
Component (B): a cationic polymerization initiator including a cation moiety and an anion moiety containing a gallium atom.

### Addendum 2

The curable composition described in Addendum 1, where the compound including the alicyclic epoxy group and including no ester bond in the component (A) is a compound represented by formula (a-1) given below.

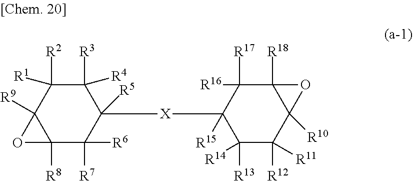

In the formula, R¹ to R¹⁸ are identical to or different from each other and each represent a hydrogen atom, a halogen atom, a hydrocarbon group which may contain an oxygen atom or a halogen atom, or an alkoxy group which may include a substituent. X represents a single bond or a linking group (excluding a linking group containing an ester bond).

### Addendum 3

The curable composition described in Addendum 1 or 2, where the anion moiety of the component (B) is an anion represented by formula (1) given below.

[Chem. 21]

[(R)ₙGaF₄₋ₙ]⁻ (1)

In the formula (1), R represents a monovalent hydrocarbon group or a monovalent fluorohydrocarbon group. n represents an integer of 1 to 4.

### Addendum 4

The curable composition described in any one of Addenda 1 to 3, where the anion moiety of the component (B) is an anion represented by formula (2) given below.

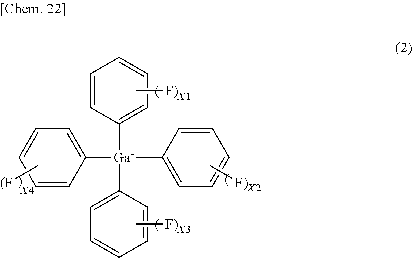

In the formula (2), X1 to X4 are identical to or different from each other and each represent an integer of 0 to 5, and the total sum of all of X1 to X4 is 1 or more.

### Addendum 5

The curable composition described in any one of Addenda 1 to 4, further including a component (C):
Component (C): a siloxane compound including two or more epoxy groups in a molecule.

### Addendum 6

The curable composition described in Addendum 5, where at least one of the epoxy groups included in the siloxane compound having two or more epoxy groups in the molecule of the component (C) is an alicyclic epoxy group.

### Addendum 7

The curable composition described in any one of Addenda 1 to 6, further containing a component (D):
Component (D): a hydrogenated glycidyl ether-based epoxy compound.

### Addendum 8

The curable composition described in any one of Addenda 1 to 7 is a curable composition for a wafer-level lens.

### Addendum 9

A cured product of the curable composition described in any one of Addenda 1 to 8.

### Addendum 10

A wafer-level lens including a cured product of the curable composition described in Addendum 8.

### Addendum 11

An optical device equipped with the wafer-level lens described in Addendum 10.

### Addendum 12

A laminated wafer-level lens, which is a laminate of a plurality of wafer-level lenses and includes at least the wafer-level lens described in Addendum 10 as a wafer-level lens constituting the laminate.

### Addendum 13

An optical device equipped with the laminated wafer-level lens described in Addendum 12.

### Addendum 14

A method for producing a wafer-level lens that includes subjecting the curable composition described in Addendum 8 to a casting or injection molding method.

### Addendum 15

The method for producing the wafer-level lens described in Addendum 14, where the casting molding method includes all of 1a, 2a, and 3a:
1a: preparing a wafer-level lens mold including one or more lens molds,
2a: bringing the curable composition into contact with the wafer-level lens mold, and
3a: curing the curable composition by heating and/or light irradiation.

### Addendum 16

The method for producing the wafer-level lens described in Addendum 15, where the casting molding method further includes 4a:
4a: annealing the cured curable composition.

### Addendum 17

The method for producing the wafer-level lens described in Addendum 15 or 16, where the casting molding method further includes 5a:
5a: cutting the cured curable composition.

### Addendum 18

The method for producing the wafer-level lens described in Addendum 14, where the injection molding method includes all of 1b, 2b, and 3b:
1b: preparing a wafer-level lens mold including one or more lens molds,
2b: injecting the curable composition into the wafer-level lens mold, and
3b: curing the curable composition by heating and/or light irradiation.

### Addendum 19

The method for producing the wafer-level lens described in Addendum 18, where the injection molding method further includes 4b:
4b: annealing the cured curable composition.

### Addendum 20

A method for producing the laminated wafer-level lens described in Addendum 12, the method including all of 1c, 2c, 3c, 4c, and 5c:
1c: preparing a wafer-level lens mold including one or more lens molds,
2c: bringing the curable composition described in Addendum 8 into contact with the wafer-level lens mold,
3c: curing the curable composition by heating and/or light irradiation to form a wafer-level lens sheet,
4c: laminating a plurality of wafer-level lens sheets including the wafer-level lens sheet described above to form a wafer-level lens sheet laminate, and
5c: cutting the wafer-level lens sheet laminate.

### Addendum 21

The method for producing the laminated wafer-level lens described in Addendum 20, further including 6c between 3c and 4c:
6c: annealing the wafer-level lens sheet.

### INDUSTRIAL APPLICABILITY

The curable composition of the present disclosure is a curable composition suitable for obtaining a wafer-level lens (curable composition for a wafer-level lens).

1. A curable composition comprising components (A) and (B),
component (A): a compound including an alicyclic epoxy group and including no ester bond, and
component (B): a cationic polymerization initiator including a cation moiety and an anion moiety containing a gallium atom.

2. The curable composition according to claim 1,
wherein the compound including the alicyclic epoxy group and including no ester bond in the component (A) is a compound represented by formula (a-1), 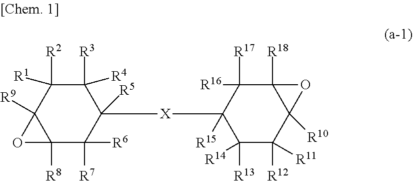
where R¹ to R¹⁸ are identical to or different from each other and each represent a hydrogen atom, a halogen atom, a hydrocarbon group that may contain an oxygen atom or a halogen atom, or an alkoxy group that may include a substituent; and X represents a single bond or a linking group (excluding a linking group containing an ester bond).

3. The curable composition according to claim 1,
wherein the anion moiety of the component (B) is an anion represented by formula (1),
[Chem. 2]
[(R)ₙGaF₄₋ₙ]⁻ (1)
where R represents a monovalent hydrocarbon group or a monovalent fluorohydrocarbon group, and n represents an integer of 1 to 4.

4. The curable composition according to claim 1,
wherein the anion moiety of the component (B) is an anion represented by formula (2), 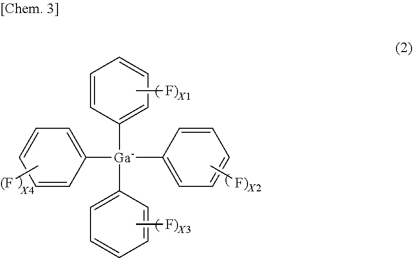
where X1 to X4 are identical to or different from each other and each represent an integer of 0 to 5, and the total sum of all of X1 to X4 is 1 or more.

5. The curable composition according to claim 1, further comprising a component (C),
component (C): a siloxane compound including two or more epoxy groups in a molecule.

6. The curable composition according to claim 5,
wherein at least one of the epoxy groups included in the siloxane compound having two or more epoxy groups in a molecule of the component (C) is an alicyclic epoxy group.

7. The curable composition according to claim 1, further comprising a component (D),
component (D): a hydrogenated glycidyl ether-based epoxy compound.

8. The curable composition according to claim 1, wherein the curable composition serves as a curable composition for a wafer-level lens.

9. A cured product of the curable composition described in claim 1.

10. A wafer-level lens comprising a cured product of the curable composition described in claim 8.

11. An optical device equipped with the wafer-level lens described in claim 10.

12. A laminated wafer-level lens being a laminate of a plurality of wafer-level lenses, the laminated wafer-level lens comprising:
at least the wafer-level lens described in claim 10 as a wafer-level lens constituting the laminate.

13. An optical device equipped with the laminated wafer-level lens described in claim 12.

14. A method for producing a wafer-level lens, the method comprising:
subjecting the curable composition described in claim 8 to a casting molding method or an injection molding method.

15. The method for producing the wafer-level lens according to claim 14, wherein the casting molding method includes all of 1a, 2a and 3a:
1a: preparing a wafer-level lens mold including one or more lens molds,
2a: bringing the curable composition into contact with the wafer-level lens mold, and
3a: curing the curable composition by heating and/or light irradiation.

16. The method for producing the wafer-level lens according to claim 15,
wherein the casting molding method further includes:
4a: annealing the cured curable composition.

17. The method for producing the wafer-level lens according to claim 15,
wherein the casting molding method further includes:
5a: cutting the cured curable composition.

18. The method for producing the wafer-level lens according to claim 14,
wherein the injection molding method includes all of 1b, 2b, and 3b:
1b: preparing a wafer-level lens mold including one or more lens molds,
2b: injecting the curable composition into the wafer-level lens mold, and
3b: curing the curable composition by heating and/or light irradiation.

19. The method for producing the wafer-level lens according to claim 18,
wherein the injection molding method further includes:
4b: annealing the cured curable composition.

20. A method for producing a laminated wafer-level lens, the method comprising all of 1c, 2c, 3c, 4c, and 5c:
1c: preparing a wafer-level lens mold including one or more lens molds,
2c: bringing the curable composition described in claim 8 into contact with the wafer-level lens mold,
3c: curing the curable composition by heating and/or light irradiation to form a wafer-level lens sheet,
4c: laminating a plurality of wafer-level lens sheets including the wafer-level lens sheet to form a wafer-level lens sheet laminate, and
5c: cutting the wafer-level lens sheet laminate.

21. The method for producing the laminated wafer-level lens according to claim 20, the method further comprising 6c between 3c and 4c:
6c: annealing the wafer-level lens sheet.
